(19) United States
(12) Patent Application Publication
(10) Pub. No.: US 2012/0062866 A1
(43) Pub. Date: Mar. 15, 2012

(54) MICROCHANNEL-COOLED COILS OF ELECTROMAGNETIC ACTUATORS EXHIBITING REDUCED EDDY-CURRENT DRAG

(75) Inventors: Michael B. Binnard, Belmont, CA (US); Scott Coakley, Belmont, CA (US); Alex Ka Tim Poon, San Ramon, CA (US); Masahiro Totsu, Kamakura (JP); Derek Coon, Redwood City, CA (US); Leonard Wai Fung Kho, San Francisco, CA (US); Gaurav Keswani, Fremont, CA (US); Alexander Cooper, Belmont, CA (US); Michel Pharand, Los Gatos, CA (US); Matt Bjork, Oakland, CA (US)

(73) Assignee: Nikon Corporation

(21) Appl. No.: 13/225,235

(22) Filed: Sep. 2, 2011

Related U.S. Application Data
(60) Provisional application No. 61/380,159, filed on Sep. 3, 2010.
(60) Provisional application No. 61/380,154, filed on Sep. 3, 2010.

(51) Int. Cl. G03B 27/58; H02K 41/02

(52) U.S. Cl. 355/72; 310/12.29; 310/12.06

(57) ABSTRACT

Electromagnetic actuators are disclosed having at least one actively cooled coil assembly. Exemplary actuators are linear and planar motors of which the cooled coil assembly has a coil having first and second main surfaces. A respective thermally conductive cooling plate is in thermal contact with at least one main surface of the coil. Defined in or on each cooling plate is a coolant passageway that conducts a liquid coolant. A primary pattern of the coolant passageway is coextensive with at least part of the main surface of the coil. The primary pattern can have a secondary pattern through which coolant flows in a manner reducing eddy-current losses. An exemplary secondary pattern is serpentine. An exemplary primary pattern is radial or has a radial aspect, such as an X-shaped pattern. The devices exhibit reduced eddy-current drag.

This application claims priority to and the benefit of U.S. Provisional Patent Application No. 61/380,159, filed on Sep. 3, 2010, and U.S. Provisional Patent Application No. 61/380,154, filed on Sep. 3, 2010, both of which are incorporated herein by reference in their respective entireties.

### FIELD

This disclosure pertains to high-precision workpiece-positioning devices as used in, for example, microlithography systems. More specifically, this disclosure pertains to certain types of electromagnetic motors (namely linear motors and planar motors) used in these systems that include multiple electrical coil assemblies that produce heat when electrically energized. This disclosure also pertains to devices and methods for cooling such motors, particularly for use in high-precision systems, in a way that reduces or at least does not contribute to formation of electrical eddy-current drag.

### BACKGROUND

Many types of precision systems utilize electromagnetic motors and other actuators for precise positioning of an object such as a workpiece. Examples of such precision systems are certain types of microlithography systems, in which the object (e.g., a wafer of which the surface is to he patterned, or a reticle defining the pattern) is mounted on a movable stage that is moved and positioned using one or more stage actuators. The stage actuators are frequently configured as linear motors, which are capable of producing highly accurate stage motion and positioning, especially in their principal movement directions. A linear motor for these applications typically comprises an assembly of multiple coils and at least one linear array of permanent magnets. Electrical energization of the coils causes electromagnetic interaction of the coil assembly and magnet array with each other, resulting in motion of the coil assembly or magnet array relative to the other. Usually, the coils are the movable portion (“armature” or “commutator”) of the linear motor, and the magnet array is the stationary portion (“stator”) of the motor. In this usual configuration of a linear motor, the energized coil assembly moves relative to a stationary magnet array. By coupling a stage or other movable body to the coil assembly, electrical energization of the coils produces corresponding motion of the body relative to the magnet array.

Under serious consideration for use in microlithography systems are planar motors that also comprise magnet arrays (two-dimensional rather than one-dimensional as in linear motors) and electrically actuatable coil assemblies. Again, when electrically energized the coil assembly of the planar motor moves relative to the magnet array. Planar motors advantageously can provide motion in three to six degrees of freedom, whereas linear motors tend to provide motion mostly in only one degree of freedom.

In linear and planar motors, electrical energization of the coils results in heat production by the coils. If not removed or otherwise controlled, this heat can propagate to other regions of a precision system, resulting in movement and positioning errors, for example. Hence, for the most extreme applications, it is desirable that linear and planar motors be cooled to remove or at least minimize the adverse effects of temperature variations in the motor on its motion and positioning accuracy. For example, heating of the coils tends to increase their electrical resistance, which with continued energization can cause the coils to produce even more heat and further reduce motor performance. In addition, heat produced by the motor tends to heat surrounding air, thereby producing convection that can impose significant changes in the index of refraction of local air, particularly in the vicinity of nearby laser interferometers and other high-precision optical systems. These changes in refractive index can also significantly degrade the accuracy and precision of work performed by the system.

There have been various attempts to cool electromagnetic motors, such as linear and planar motors, actively. For example, some conventional approaches involved enclosing the coils in a water-cooled housing, or encapsulating or potting the motor-coil assembly in a cured polymeric resin such as epoxy, to form a “capsule” that can be immersed in coolant. Cooling coils in an encapsulated coil assembly typically requires that heat be conducted from the coils through the polymeric resin (which often has poor thermal conductivity) to the cooling liquid. As a result, significant thermal gradients can form between the coolant and the coils, resulting in high coil temperatures, cooling inefficiency, and inadequate or inconsistent cooling of the coils. An example of this technique is discussed in U.S. Pat. No. 4,749,921, in which linear motor coils are potted in a resin with coolant tubes. Coolant is passed through the tubes at least during motor actuation. This scheme is difficult to implement and does not provide consistent results. The scheme can usually be done only by wrapping the coil assembly with tubing and encapsulating the entire assembly. This configuration does not exhibit satisfactory performance for high-precision systems because, inter alia, the assembly is bulky, and the motor is still not adequately isolated from outside air.

Other conventional approaches are discussed in U.S. Pat. Nos. 4,625,132; 4,749,921; 4,839,545; 4,906,878; 4,916,340; 5,073,734; 5,998,889, 6,114,781; 6,278,203; and 6,762,516. Several of these references discuss sandwiching entire coil assemblies between coolant-conducting plates placed in proximity to (but separate from) the motor coils. The resulting large volume containing the coolant requires that coolant be delivered to the plates under high pressure. These high coolant pressures are difficult to handle because they tend to cause bulging of the coolant passageways in the plates, which introduces distortion. To prevent bulging, substantial structure is required to prevent distortion due to coolant pressure, despite the fact that high pressure is desirable to achieve increased flow of coolant through the coil plates. Applicants have also discovered that these conventional schemes tend to contribute to electrical eddy-current drag in the motors, which robs the motors of efficiency and introduces movement and positioning inaccuracy to the motors.

Conventional cooled coil assemblies in which coolant is flowed through a housing surrounding the coils requires that any mounting bolts or electrical connections to and from the assembly pass through the cooling housing. This requires use of static seals, which are leak-prone, and introduces many possibilities for coolant leakage.

Furthermore, these conventional cooling systems are more bulky than desired for use on the latest-generation microlithography systems.

According to another conventional approach, the coils are placed directly into a coolant liquid, thereby avoiding the need for a protective housing for the coolant. However, this approach requires a use of an electrically non-conductive coolant, thereby preventing use of water, which is much more effective as a coolant than many non-aqueous electrically non-conductive coolants. There is also the possibility that the coolant will attack the insulation on the coil wires and lead to premature failure of the coils.

### SUMMARY

The invention disclosed herein has multiple aspects. A first aspect is in the context of a linear or planar motor, and is directed to an actively cooled coil assembly of one of said motors. An exemplary embodiment of such an assembly comprises a coil having first and second main surfaces. Also included is a respective thermally conductive cooling plate in thermal contact with at least one main surface of the coil. A coolant passageway is defined in or on the cooling plate, and a liquid coolant passes through the coolant passageway. The coolant passageway has a primary pattern that is coextensive with at least part of the main surface of the coil. The primary pattern can include a secondary pattern. Either the primary pattern or the secondary pattern. (if present) can he configured to avoid large continuous areas and thereby reduce eddy-current losses in the cooling plate.

As noted, the primary pattern can include a secondary pattern. The secondary pattern can have a shape that is configured to reduce the extent of continuous areas, and thereby reduce eddy-current losses in the cooling plate. For example, the secondary pattern can be serpentine. Alternatively or in addition, the primary pattern can be serpentine. Exemplary primary patterns include U-shaped patterns and X-shaped patterns. Either pattern can have a radial shape or have a radial aspect including arms or branches having respective termini. Either or both patterns can include microchannels.

An assembly having a radially shaped pattern can further comprise either a coolant inlet or a coolant outlet situated substantially in the middle of the pattern and respective coolant outlets or inlets, respectively, situated substantially at the termini of the arms. In such a configuration coolant flow enters the coolant passageway through at least one coolant inlet, flows through the arms, and exits the coolant passageway through at least one coolant outlet. A respective secondary pattern can extend along each arm to impose a non-cyclic flow of coolant as the coolant flows through the arms. Meanwhile, the coolant has good thermal contact with the corresponding regions of the coil so as to remove heat from the coil.

In other embodiments the coil is a flat coil with first and second planar main surfaces. At least one main surface includes a respective cooling plate in thermal contact therewith, at least one cooling plate includes a respective coolant passageway defined in or on the cooling plate, and at least one cooling plate includes a liquid coolant passing through the coolant passageway. The coolant passageway can have a primary pattern that is coextensive with the respective main surface of the respective coil. The primary pattern is configured to reduce the extent of continuous area, and thereby reduce eddy-current losses in the cooling plate.

In other embodiments an outer plate is included that is situated such that the cooling plate is sandwiched between the outer plate and the coil. The cooling plate is configured to be compressed by the outer plate toward the coil to improve thermal contact of the cooling plate with the respective main surface of the coil.

In some embodiments the assembly further comprises a “static mixer,” as defined herein, located in the coolant passageway.

Some embodiments can also include a thermally conductive substance between the cooling plate and the respective main surface of the coil. Exemplary substances include, but are not limited to, thermally conductive paste, soft metals, etc.

Another aspect is directed to electromagnetic motors that comprise a stator and a commutator. In many embodiments the commutator comprises multiple electrically energizable coils (e.g., wire coils) that are movable (when electrically energized) relative to the stator. The stator can be an array of permanent magnets in these embodiments, which are called “moving-coil” motors. In other embodiments the commutator is an array of magnets that moves relative to a fixed array of multiple coils serving as the stator. These embodiments are called “moving-magnet” motors. Example moving-magnet motors and moving-coil motors include linear motors and planar motors.

The motor can include at least one respective unit of thermally conductive material in thermal contact with at least one coil so as to conduct heat from the coil. The unit of thermally conductive material desirably defines a respective coolant passageway. The coolant passageway can have a primary pattern that is coextensive with at least a portion of the respective coil. The coolant passageway can also include a secondary pattern, and the secondary pattern can include at least one microchannel. The motor also includes a thermally conductive liquid coolant in the coolant passageway. The coolant passageway produces coolant flow therethrough in a manner that reduces eddy-current losses in the thermally conductive material. The coolant flowing in the coolant passageway is in thermal contact with the respective unit of thermally conductive material to remove heat from the respective unit of thermally conductive material and thus from the respective coil.

In embodiments in which the motor is a linear motor including multiple coils, at least one coil has a respective substantially planar main surface. At least one coil is incorporated into a respective coil unit. In a coil unit, the main surface of the respective coil includes a respective unit of the thermally conductive material in thermal contact therewith. The unit of thermally conductive material desirably is configured as a coolant “plate” that can easily be placed in thermal contact with the planar main surface of the coil. To such end, the coolant plate desirably has a substantially planar surface. At least one coolant plate in the coil unit defines a coolant passageway. The coolant passageway can include a primary pattern. The primary pattern can include a secondary pattern. Either pattern, or both patterns, can include at least one microchannel. The pattern(s) desirably are configured to reduce the extent of continuous area, and thereby reduce eddy-current losses in the thermally conductive material. The assumption here is that the thermally conductive material is also electrically conductive. This is true for metal microchannels, for example, but the thermally conductive material could also be a ceramic such as AlN, in which case eddy-current drag is a non-issue.

Certain embodiments of coil assemblies have a modular form in which one or more individual coils has its own cooling; plate(s). Particularly in configurations involving multiple cooling plates, the cooling plates are hydraulically connected together using at least one manifold from which the cooling plates can be easily disconnected. At least one cooling plate is configured according to any of the various embodiments summarized above, and is configured to reduce the extent of continuous area and thereby reduce eddy-current losses in the thermally conductive material. These modular form coil assemblies can be used, for example, in moving-coil or moving-magnet planar motors or in moving-coil or moving-magnet linear motors.

In some embodiments at least one coil unit includes respective outer plates situated such that the cooling plates are sandwiched between the respective outer plate and the coil. Each outer plate can be urged toward the coil to provide thermal contact of the cooling plate with the respective main surface of the respective coil.

In some embodiments of the motors summarized above, at least one coolant passageway includes a respective static mixer, as defined herein, located in the respective secondary pattern.

Another aspect of the invention is directed to cooling devices for electrically actuated coils. An exemplary embodiment comprises an actively cooled member in thermal contact with a coil, wherein the cooled member has at least one liquid inlet and at least one liquid outlet to conduct cooling liquid through a liquid passageway in or on the member. The cooling device can also include a static-mixing structure, as defined herein, situated in at least one liquid passageway and configured to induce mixing of the liquid as the liquid flows through the passageway. In some embodiments the static mixing structure is an open-cell foam.

Other aspects of the invention are directed to precision systems (e.g., microlithography systems, comprising linear and/or planar motors as disclosed herein.

Certain embodiments of motors as disclosed herein provide at least the following advantages:

(a) devices for cooling coils in such motors can he made more compact;

(b) coil potting is eliminated;

(c) coil assemblies can be modular and hence simpler, allowing ready access to individual coils and other components without having to disassemble an entire motor-coil assembly;

(d) provides better thermal performance than conventional motor cooling systems;

(e) eliminates having to contain the coils in a large, pressurized, coolant vessel to provide coolant circulation around the coils;

(f) by eliminating the pressure vessel, electrical pass-throughs through it are eliminated;

(g) since each coil can be individually cooled using its own respective cooling plate(s), eddy-current losses are reduced; and

(h) the cooling plates can include coolant passageways configured (e.g., using microchannels and/or particular patterns of coolant passageways) that further reduce eddy-current losses.

The foregoing and additional features and advantages of the subject methods will be more readily apparent from the following detailed description, which proceeds with reference to the accompanying drawings.

### BRIEF DESCRIPTION OF THE DRAWINGS

FIG. 1 is an isometric diagram showing the sandwiching of a flat coil between two actively cooled coolant plates, as described in the first representative embodiment. Also shown is an exemplary manner, using “C”-clamps, of holding the sandwich together to establish and maintain good thermal contact of the coolant plates to respective sides of the coil.

FIGS. 2A and 2B depict a flat coil sandwiched between two coolant plates having coolant passageways that continue from one coolant plate to the other, as described in the second representative embodiment.

FIG. 3A is an isometric diagram showing one exemplary manner of constructing a coolant plate, in which a main surface of a first plate component is machined or etched to form open channels, followed by bonding a second plate component to the main surface of the first plate component, as described in the first representative embodiment.

FIG. 3B is an isometric diagram showing another exemplary manner of constructing a coolant plate, in which a center plate (cut out to define coolant channels) is sandwiched between two solid plates. The three plates are superposed and bonded together. Inlet and outlet ports can be located on one of the solid plates, or on both, or one on the first solid plate and the other on the second solid plate.

FIG. 4 is a schematic diagram of an exemplary cooling circuit described in the first representative embodiment.

FIG. 5 depicts a cooling plate on which one or more coolant conduits have been attached to an outside main surface of the cooling plate, as described in the first representative embodiment.

FIG. 6 is a perspective view of the upper surface of a planar-motor coil assembly (i.e., surface facing away from the permanent-magnet array in a planar motor), as described in the third representative embodiment,

FIG. 7 is a perspective view of the lower side of the planar-motor coil assembly e side facing the permanent-magnet array), as described in the third representative embodiment, with the cover plate removed to show underlying detail, including details of coil units in the housing and their relative orientations.

FIG. 8 is a perspective exploded view of a coil unit, showing the manner in which the coils (i.e., two coil halves of a split core), their cores, the microchannel cooling assemblies, and the clamping plates are stacked in the third representative embodiment.

FIG. 9 is a perspective view of a quarter-motor manifold plate used in the coil assembly for a planar motor, according to the third representative embodiment. The main surface that is visible is one that normally faces away from the permanent-magnet array of the planar motor.

FIGS. 10A and 10B depict, with respect to the third representative embodiment, an upper (facing away from the permanent-magnet array) and lower (facing the permanent-magnet array) coil unit, wherein FIG. 10A shows connections of the manifold block with a quarter-motor manifold plate, and FIG. 10B shows coils and cooling plates.

FIG. 10C is a schematic diagram of coolant flow through the embodiment discussed in the third representative embodiment.

FIG. 11 is a perspective view of the manifold block used to supply coolant to and remove coolant from a planar-motor coil assembly in the third representative embodiment.

FIG. 12 is a perspective view of a cooling plate used in a planar-motor coil assembly according to the fifth representative embodiment, and used in, for example, a coil assembly according to the third representative embodiment.

FIG. 13 is a perspective exploded view of a coil unit as described in the fourth representative embodiment, showing the manner in which the coils (i.e., two coil halves of a split core), their cores, the microchannel cooling assemblies, and the clamping plates are stacked and bolted together.

FIG. 14 is a perspective view of an exemplary array, according to the fourth representative embodiment, of multiple coil assemblies, including actively cooled coil assemblies as described in the third representative embodiment.

FIGS. 15A-15C depict exemplary coolant-channel configurations in cooling plates. FIG. 15A shows a “U”-shaped primary channel configuration with no secondary channels. FIG. 15B shows a “U”-shaped primary channel configuration with a fine serpentine secondary channel, in which coolant enters the primary channel via an inlet (not shown) at the bottom of the “U.” FIG. 15C shows an “X”-shaped primary channel configuration, in which coolant enters via an inlet in the middle of the pattern and then flows through serpentine secondary channels in the arms of the “X”. The configuration shown in FIG. 15C is the most effective, of the three configurations shown, in preventing formation of electrical eddy-currents. (Actually, from the standpoint of only eddy-currents, the configuration of FIG. 15B is better than the configuration of FIG. 15C. However, the configuration of FIG. 15C is more practical in terms of exhibiting a reasonable coolant flow.)

FIG. 16 schematically depicts the results of static mixing as described in the seventh representative embodiment. In a flow conduit 400 a unit of open-cell material 402 has been placed. Coolant flows from left to right in the figure, and its flow vectors 404 indicate substantially laminar flow. As the flow enters and passes through the open-cell material 402, the flow vectors become contorted, and some of them become directed toward the walls 406, which improves cooling of the walls.

FIGS. 17A and 17B are orthographical views schematically depicting the placement of respective units of open-cell material having sufficiently small pore size at selected locations in a microchanneled coolant flowpath, as described in the seventh representative embodiment.

FIG. 18 depicts the placement of respective units of flow-mixing open-cell material, such as a foam material, relative to a coil in coolant passages located on each side of a coil in a conventional cooling jacket.

FIG. 19 is a schematic diagram of an immersion microlithography system as described briefly in the eighth representative embodiment and which is a first example of a precision system including one or more electromagnetic actuators as described herein.

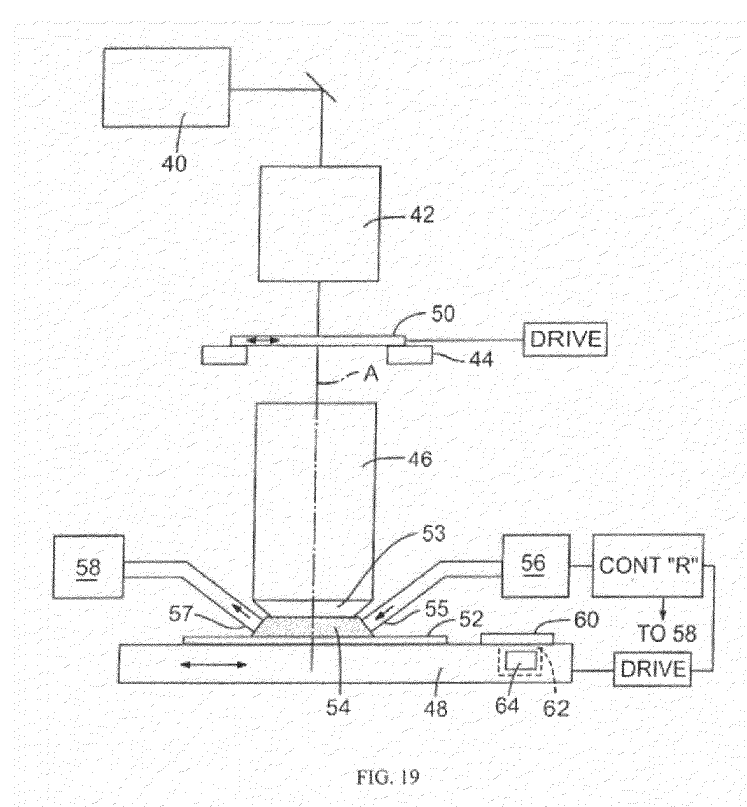

FIG. 20 is a schematic diagram of an extreme-UV microlithography system as described briefly in the eighth representative embodiment and which is a second example of a precision system including one or more electromagnetic actuators as described herein.

FIG. 21 is a process-flow diagram depicting exemplary steps associated with a process for fabricating semiconductor devices.

FIG. 22 is a process-flow diagram depicting exemplary steps associated with a processing a substrate (e.g., a wafer), as would be performed, for example, in step 704 in the process shown in FIG. 21.

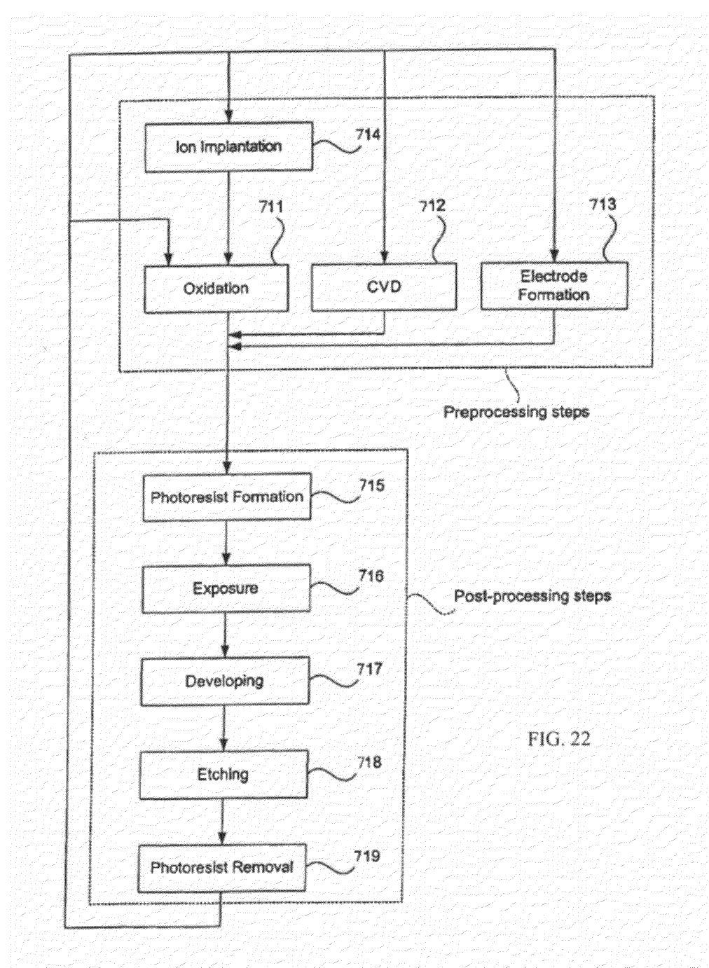

### DETAILED DESCRIPTION

This disclosure is set forth in the context of representative embodiments that are not intended to be limiting in any way.

The drawings are intended to illustrate the general manner of construction and are not necessarily to scale. In the detailed description and in the drawings themselves, specific illustrative examples are shown and described herein in detail. It will be understood, however, that the drawings and the detailed description are not intended to limit the invention to the particular forms disclosed, but are merely illustrative and intended to teach one of ordinary skill how to make and/or use the invention claimed herein.

As used in this application and in the claims, the singular forms “a,” “an,” and “the” include the plural forms unless the context clearly dictates otherwise. Additionally, the term “includes” means “comprises.” Further, the term “coupled” encompasses mechanical as well as other practical ways of coupling or linking items together, and does not exclude the presence of intermediate elements between the coupled items.

The described things and methods described herein should not be construed as being limiting in any way. This disclosure is directed toward all novel and non-obvious features and aspects of the various disclosed embodiments, alone and in various combinations and sub-combinations with one another. The disclosed things and methods are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and method. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

### Linear and Planar Motors

In general, substantially all electric motors comprise two basic portions, namely a stator and an armature. The armature also called a “commutator”) moves relative to the stator. The armature in most type of electric motors is nested in the stator and, whenever the motor is electrically energized, the armature rotates about a rotational axis, with which the stator is also coaxial, relative to the stator to produce torque.

A linear motor is an electric motor in which the stator and armature have been “unrolled” so that, instead of producing torque, it produces a linear force along the length of the motor. I.e., in a linear motor or planar motor, the energized armature does not undergo rotational motion, but rather moves linearly relative to the stator. A planar motor is basically a linear motor modified to produce motion of the commutator in a plane defined by the stator of the planar motor. In most linear motors and planar motors, the stator is a linear or planar array, respectively, of permanent magnets. In such motors the armature is an assembly of multiple coils that, when electrically energized, undergoes linear or planar motion, respectively, relative to the magnet array. During such motion of the commutator all the coils of the coil assembly move together. Thus, a “coil assembly” in the context of linear and planar motors is the group of multiple coils that moves together relative to the stator whenever the coils are being electrically energized appropriately. A coil assembly in a linear motor typically comprises at least three coils, and a coil assembly in a planar motor typically comprises twelve coils.

Another type of motor to Which this disclosure is applicable is a voice-coil motor (VCM). A VCM is a simple type of electric motor comprising a magnetic housing and a coil. Applying a voltage across the terminals of the motor causes either the housing or the coil (depending upon how the motor is mounted) to move in one direction along a given axis. Reversing the polarity of the applied voltage produces motion in the opposite direction along the axis. The force generated by the motor is proportional to the current flowing through the motor coil.

### Eddy-Current Drag

An electrical eddy-current is a current that is induced in an electrical conductor whenever the conductor is exposed to a changing magnetic field. The changing magnetic field causes a circulative flow of electrical current within the conductor. Since the conductor has non-zero electrical resistance, circulative flow of electrical current dissipates energy and can cause undesirable drag forces or heating in the motor. For example, in a moving-coil linear motor or planar motor, the coil assembly moves relative to a linear or planar array of permanent magnets. With distance over the array, the magnets alternate in polarity and magnitude. These changes in the magnetic field presented to the coil assembly cause conductive portions of the coil assembly to produce eddy-currents whenever the coil assembly is put into motion relative to the magnet array. These eddy-currents can interfere with operation of the motor, including imparting drag forces to the intended motion of the coil assembly.

The production or intensification of eddy-current drag to motor operation can be an issue whenever electrical coils of the motor are cooled in the manner described herein. One reason for this issue resides in the fact that many materials having suitable thermal conductivity for use in the several embodiments are metals, and many metals are electrically conductive. The key to reducing eddy-current drag is to avoid forming electrical eddy-currents in the first place.

### First Representative Embodiment

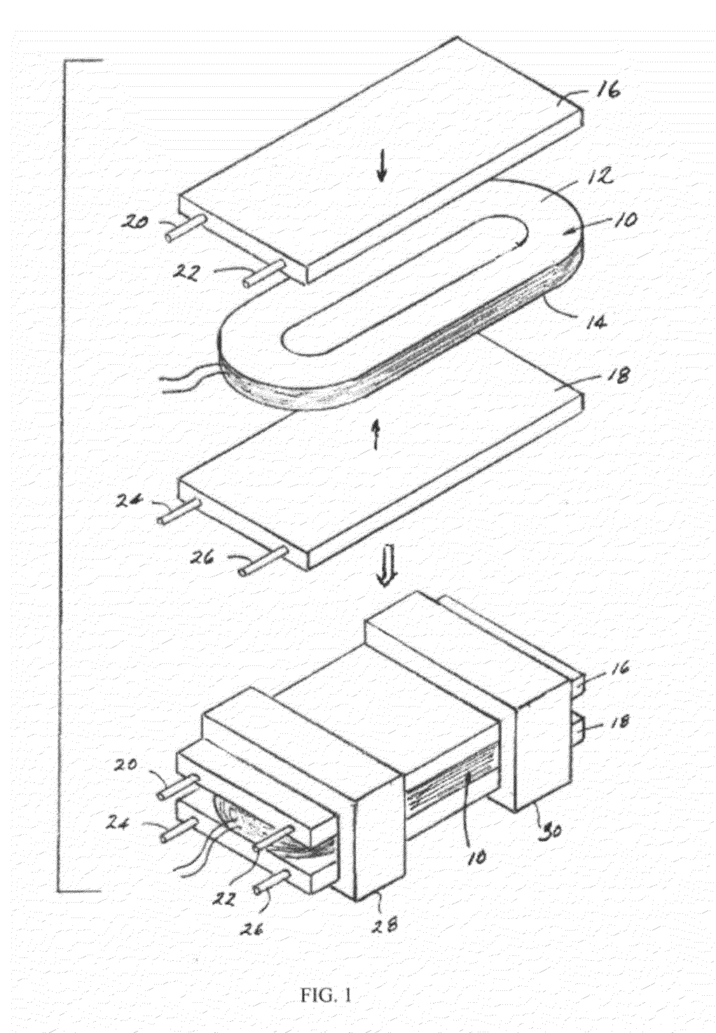

In this embodiment, individual electromagnetic coils of a coil assembly of a linear motor or planar motor are in thermal contact with individual respective thermally conducting (and actively cooled) plates or analogous bodies to cool the coils as required. Each coil desirably is configured as a flat coil 10 having a first substantially planar surface 12 and an opposing second substantially planar surface 14, as shown in FIG. 1. In this embodiment at least one substantially planar surface 12 is in thermal contact with a respective actively cooled, thermally conductive plate 16. For example, each coil 10 is sandwiched between two actively cooled, thermally conductive plates 16, 18, wherein the second plate 18 contacts the opposing substantially planar surface 14 of the coil 10.

As noted, the plates 16, 18 in this embodiment are actively cooled. In some embodiments it may be possible to achieve satisfactory results by actively cooling one of the plates 16, 18 per coil 10, with the other plate being either passively cooled or not cooled. “Active cooling” is distinguished from “passive cooling” or no cooling. Passive cooling relies principally upon conduction and/or radiative processes to remove heat from an object, without expending any energy to perform cooling. For example, passive cooling can be achieved in some instances by thermally mounting an object to be cooled to a heat sink or by relying upon naturally occurring air convection to remove heat from the object, especially of the object is warmer than the surrounding air. Active cooling requires expenditure of energy to produce cooling, such as directing a fan at the object to be cooled, performing cooling electronically (e.g., Peltier cooling), or circulating a coolant fluid relative to the object to be cooled. No cooling means that nothing is being done to remove heat.

For performing active cooling, a plate 16, 18 has one or more internal coolant channels through which a coolant fluid, usually a coolant liquid, is circulated. Desirably, the coolant channels are configured at least partially as micro-channels. To supply coolant to the micro-channels inside a plate, each plate (e.g., plate 16) can include at least one inlet port 20 and at least one outlet port 22. The inlet port 20 routes coolant into the coolant channels of the plate 16. As the coolant flows through the channels, it absorbs heat from the plate (which has absorbed heat from the coil), thereby warming the coolant and cooling the plate and coil. The outlet port 22 conducts the warmed coolant away from the plate 16. Similarly, the second plate 18 includes an inlet port 24 and an outlet port 26. By being internally liquid-cooled in this manner, at least one of the plates 16, 18 is “actively” cooled, rather than passively cooled.

For optimal heat transfer from the coil 10, a plate 16, 18 has at least some direct thermal contact with the respective surface 12, 14 of the coil 10. This thermal contact can be established and maintained by compressing the subject plate 16, 18 to the coil 10 using mechanical clamps 28, 30, bolts, or analogous fastening means. In addition, if desired or required, a thermally conductive “interface material” can be placed between the contacting surfaces to provide even better thermal conductivity from the coil to the plate. The interface material (especially if it includes an adhesive) can also be used to bond the contacting surfaces together, thereby eliminating the need for clamping, at least on a sustained basis. Examples of thermally conductive interface materials include, but are not limited to, commercial gap-filler materials, thermal pastes and greases, high-thermal-conductivity epoxies, soft metals such as indium that conform into minute gaps in solid surfaces to improve heat transfer.

The plates 16, 18 desirably are fabricated of a material having good thermal conductivity. Consequently, whenever a plate 16, 18 is in position to remove heat from the coil 10, the heat from the coil 10 is readily distributed into the plates. Materials having high thermal conductivity include various metals. Copper and aluminum alloys have particularly high thermal conductivity values among the metals. Certain non-metallic materials also have high thermal conductivity. However, many metals, including Cu and Al, are electrical conductors. Fabricating the plates 16, 18 of an electrically conductive metal in general can result in the coil assembly producing electrical eddy-currents, which can be manifest as motor “drag.” By way of example, and not intending to be limiting, the thermal conductivity values of some applicable materials are as follows:

Cu: 398 W·m⁻¹K⁻¹

Al: 236 W·m⁻¹K⁻¹

C (diamond): 1000˜2000 W·m⁻¹K⁻¹

C (carbon nanotubes): 3000˜5500 W·m^{31 1}K⁻¹

Fe: 84 W·m⁻¹K⁻¹

Stainless Steel: 16.7˜20.9 W·m⁻¹K⁻¹

For some configurations, keeping the thermal conductivity below approximately 400 W·m⁻¹K⁻¹ is desirable for ensuring that eddy-current formation is kept within practical limits. For other configurations, keeping the thermal conductivity below approximately 20 W·m⁻¹K⁻¹ is desirable. In yet other configurations, it is desirable to keep the thermal conductivity over approximately 200 W·m⁻¹K⁻¹. It is noted that thermal conductivity has nothing to do with eddy-current drag. Higher thermal conductivity is better in this application.

Minimizing electrical eddy-currents is not usually achieved by selection of material alone. Certain shapes of conductors are more susceptible to eddy-current formation than others. For example, keeping electrical conductors thin, use of laminated construction of electrical conductors, and/or avoiding large-area continuous regions of electrical conductors are three exemplary approaches to minimizing electrical eddy-currents. Another approach is fabricating the plates of a material having good thermal conductivity but poor electrical conductivity (e.g., aluminum nitride or silicon).

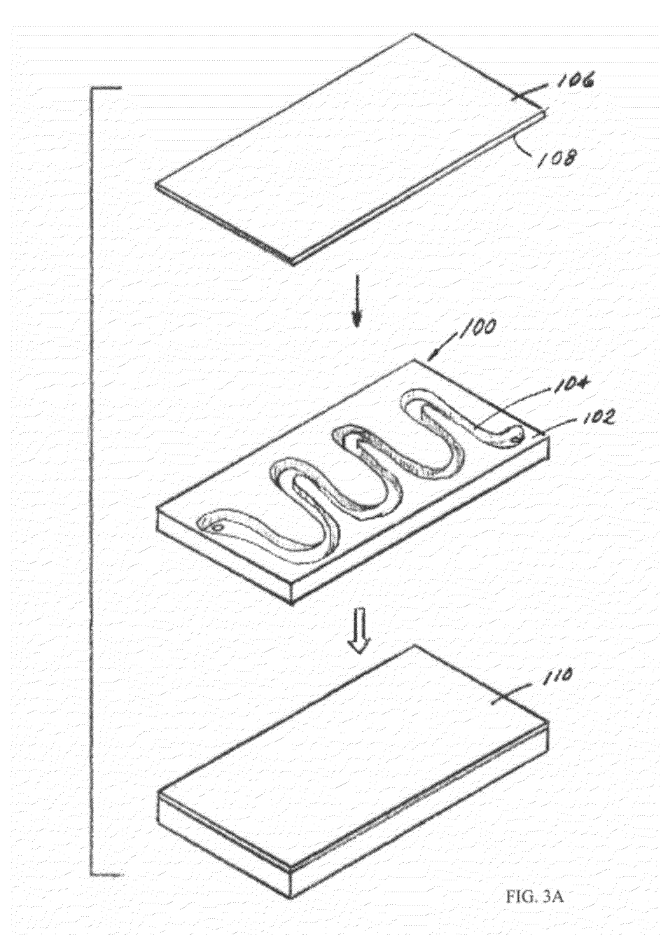

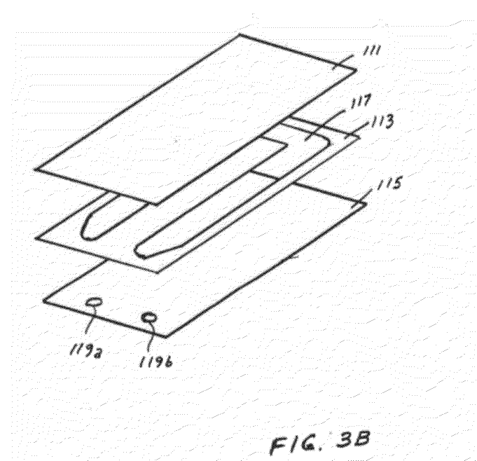

One way in which to fabricate a cooling plate is to form it with two plate components that fit together and collectively define the internal channels when the plates are bonded together (or otherwise held together) face-to-face. In many instances, the only effective way of forming internal coolant channels in a cooling plate is to machine or etch the channels into the surface of a plate component. The channels have a desired length, width, and depth. A second plate component of either the same or of a different material (that can be bonded to the first plate component) is similarly machined or etched to enclose the channels. This is shown in FIG. 3A, in which a main surface 102 of a first plate component 100 is machined or etched to form open channels 104. A second plate component 106, which can be thinner than the first plate component 100, is aligned with and bonded to the main surface 102 of the first plate component. Alternatively to forming the channels 104 in only one plate component, it is possible to machine or etch the main surfaces 102, 108 of both plate components 100, 106 to define complementary channel portions in both main surfaces, followed by bonding of the two plate components together face-to-face to form a plate assembly 110.

Another way in which to fabricate a cooling plate is by using three plates 111, 113, 115 as shown in FIG. 3B. The middle plate 113 includes a cutout 117 that defines the flowpath of coolant, and is sandwiched between solid plates 111, 115. The cutout 117 can be made by laser ablation, machining, or etching, for example. The three plates 111, 113, 115 are bonded together in this superposed manner. (The of the solid plates 115 includes coolant inlet and outlet ports 119a, 119b, respectively, for coolant to enter and exit the cutout. The plates 111, 113, 115 can be made of electrically non-conductive material.

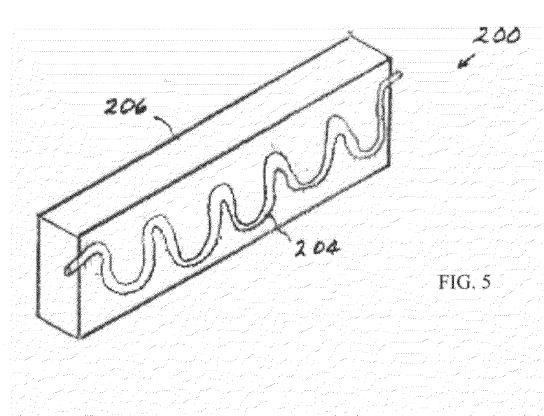

Yet another possible configuration of a cooling plate involves bonding one or more conduits to an outside main surface of a cooling plate, as shown for example in FIG. 5. In the figure, a cooling plate 200 is shown having an outside main surface 202. The outside main surface 202 includes a conduit 204 arranged in a serpentine (or other suitable) pattern and bonded (e.g., brazed, soldered, welded, or adhesive-bonded) to the outside main surface 202 of the cooling plate. The reverse main surface 206 of the cooling plate 200 thermally contacts the coil in the manner described above. The cooling plate 200 may additionally have internal cooling channels (not detailed), such as described above.

As noted, a cooling plate defines one or more conduits or channels into which a liquid coolant is delivered (by at least one inlet port) and circulated. Flow of coolant through the channels allows the coolant to absorb heat from the plate and carry the heat away from the respective coil. Since the cooling plate prevents the coolant from contacting the coil, various coolants that are compatible with the material of the plate can be used, including coolants that otherwise could damage the coil if brought into direct contact with the it. It is desirable to use a liquid coolant exhibiting good thermal-cooling performance, such as any of various commercial heat-transfer fluids (e.g., Fluorinert™ or one of the Freons™) or water.

The geometry (i.e., configuration) of the channels desirably is optimized for effective heat transfer from the material of the cooling plate to the circulating coolant while avoiding any relatively large, continuous areas. For example, but without intending to be limiting in any way, the channels can be configured, in whole or in part, as micro-channels. “Microchannels” are channels or conduits having at least one dimension less than 1 mm. For example, a microchannel can have a length of multiple millimeters, a width of several mm, and a height of a fraction of a millimeter. In certain embodiments, coolant supplied to one plate can be circulated to another plate, for example from a first plate contacting a coil to a second plate also contacting the coil. In yet another example, phase-change cooling can be applied to remove heat from the plates. In many instances, the flow of liquid coolant through the channels of the plates (especially through microchannels of the plates) tends to be laminar rather than turbulent. Although microchannels are useful in many embodiments, this is not to be regarded as limiting. In some embodiments, cooling plates can have one or more channels that are larger than microchannels.

The range of possible channel patterns embodied in a cooling plate is substantially unlimited. For example, the channels can be configured with a radial configuration such that coolant introduced via a centrally located channel flows radially outward in respective channels toward the edges of the plate before being collected and routed to the outlet port. As another example, the channels can be configured to provide a coolant flow path that is at least partially serpentine. Many other channel configurations are possible, depending upon the particular heat profile of the coil and on other factors.

Another exemplary channel configuration comprises at least one primary and at least one secondary portion. For example, the secondary portion can comprise one or more microchannels, and the primary portion can comprise other channels that distribute flow to and collect flow from the secondary portion. Any such channel configuration desirably prevents circular flow and eddy-currents in the coolant flowing through the channel.

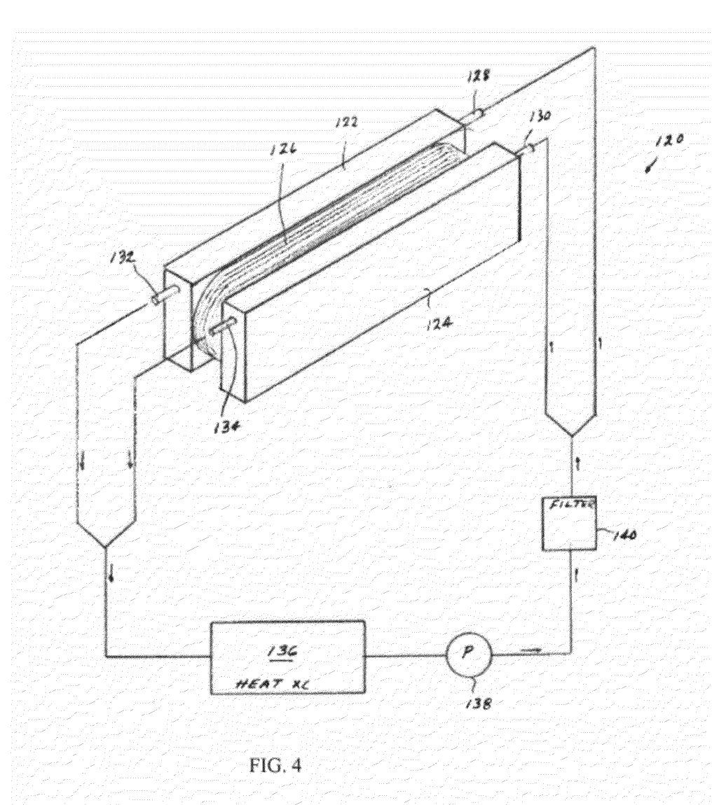

An embodiment of a cooling circuit is shown in FIG. 4. The circuit includes a coil assembly having two cooling plates 122, 124. A coil 126 is sandwiched between the cooling plates 122, 124. Each cooling plate has a respective inlet port 128, 130 and a respective outlet port 132, 134. The two inlet ports 128, 130 are connected together in parallel, as are the two outlet ports 132, 134. Liquid coolant from a heat exchanger 136 is urged by a pump 138 or analogous device to flow through a filter 140 and to the inlet ports 128, 130 in parallel. After circulating through channels in or on the cooling plates 122, 124, the coolant returns to the heat exchanger 136. The heat exchanger 136, pump 138, and filter 140 can be part of a more general cooling system used in the precision system, such as (but not limited to), a stage-cooling system.

### Second Representative Embodiment

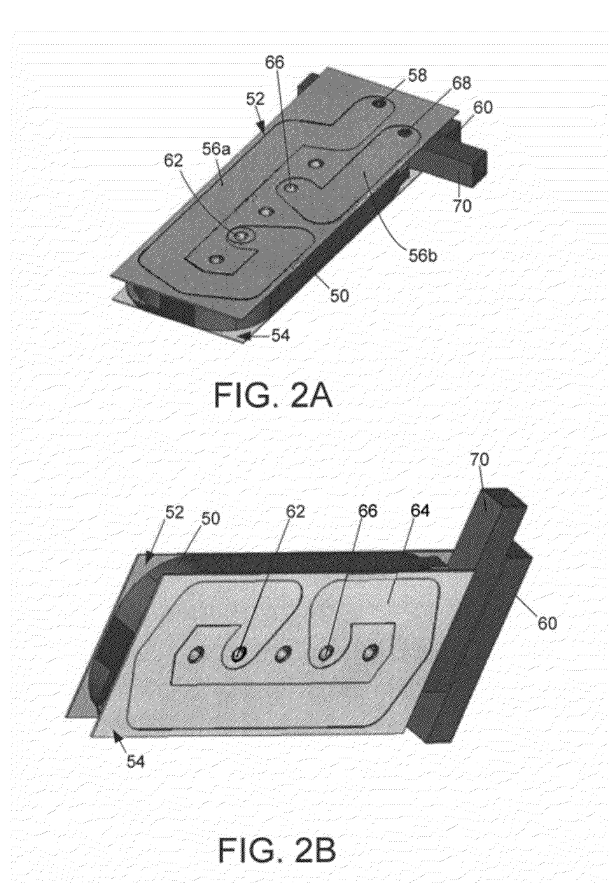

A second embodiment is depicted in FIGS. 2A and 2B, in which liquid coolant is circulated through one plate and then circulated through at least a portion of a second plate before being conducted away from the coil assembly. Referring first to FIG. 2A, a flat coil 50 is shown sandwiched between a first cooling plate 52 and a second cooling plate 54. Coolant channels 56a, 56b in the first cooling plate 52 are visible in the figure because a cover plate (not shown) has been removed to show underlying detail. Similarly, in FIG. 2B. Coolant channels 64 in the second plate 54 are visible in the figure because a respective cover plate (not shown) has been removed to show underlying detail. Returning to FIG. 2A, the cooling channels in the first plate 52 include a first portion 56a and a second portion 56b. The first portion 56a is supplied with coolant fluid via an inlet port 58 that is coupled to a first fluid conduit 60. Coolant supplied to the first portion 56a by the inlet port 58 passes through a first feed-through port 62 to the coolant channel 64 in the second cooling plate 54. After flowing through the coolant channel 64, the coolant passes through a second feed-through port 66 to the second cooling-channel portion 56b in the first cooling plate 52. After passing through the second cooling-channel portion 56b, the coolant exits via an outlet port 68 to a second fluid conduit 70.

The configurations of the first and second embodiments (FIGS. 1 and 2A-2B, respectively) are representative of using one or more plates of thermally conductive material, in contact with respective surfaces (or portions of respective surfaces) of respective motor coils, to remove heat from the coils. Since the plates are in good thermal contact with the respective coils, and since the plates are actively cooled by a circulating coolant, the plates redistribute heat received from the coil into the entire volume of the plates, thereby making the coil temperature more uniform. Thermal interface materials and/or mechanical clamping or bonding can be used to improve heat flow between the coil 50 and the cooling plates 52, 54. One or more of the plates 52, 54 is internally cooled by coolant flow in channels in or on the plate. This configuration is particularly useful for applications in linear and planar motors where space availability is extremely limited. These configurations also utilize less volume of coolant than conventional cooling systems.

The channels shown in FIGS. 2A-2B may have continuous areas that are too large for adequate control of electrical eddy-currents. Eddy-currents can be substantially reduced by, for example, subdividing the channels and/or making them narrower, shallower, more branched, and/or more convoluted. For example, the channels can be configured with at least one primary pattern and at least one secondary pattern. See Fourth Representative Embodiment.

### Third Representative Embodiment

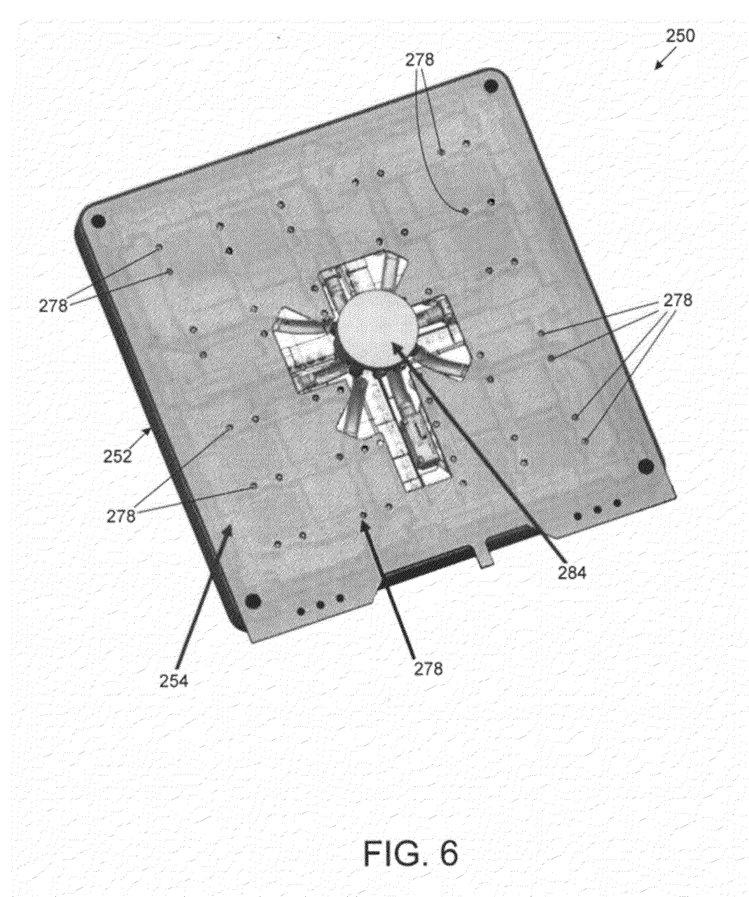

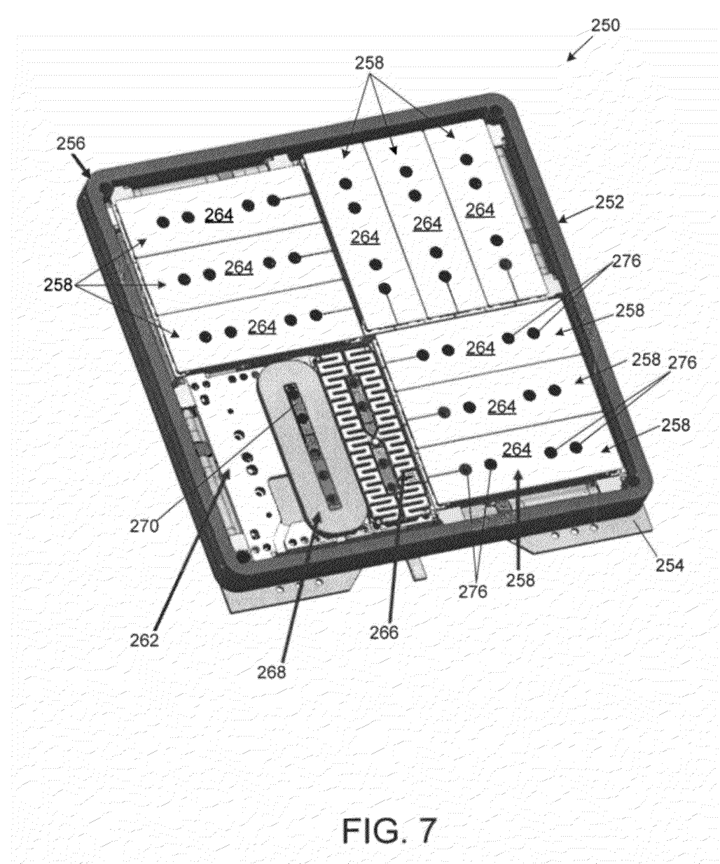

This embodiment is directed to a coil assembly 250 useful as an armature in a planar motor. The outside details of the coil assembly 250 are shown in FIGS. 6 and 7, wherein FIG. 6 is a perspective view of the upper side of the coil assembly, and FIG. 7 is a perspective view of the lower side. The coil assembly 250 comprises a housing 252, which comprises an upper cover plate 254, a lower cover plate (not shown in FIG. 7), and a side-wall portion 256 sandwiched between the upper cover plate and lower cover plate. The lower and upper cover plates can be made of, for example, carbon-fiber-reinforced polymer (CFRP).

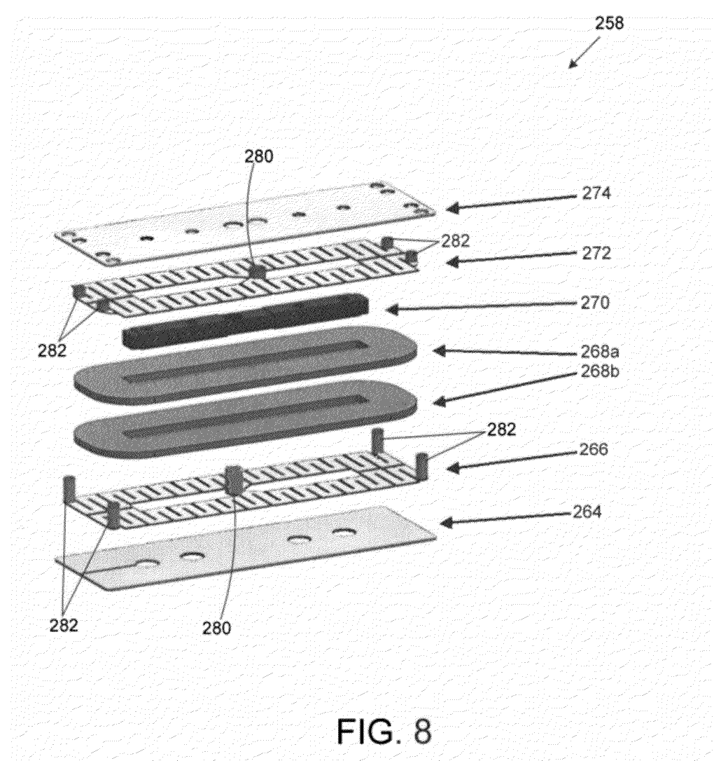

Turning now to FIG. 7, the interior of the housing 252 can be seen. In the housing 252, twelve individual coil units 258 are contained in groups of three that are arranged side-by-side. Each group of three coil units 258 includes a quarter-motor manifold plate 262. As shown in FIG. 8, each coil unit 258 comprises a bottom plate 264, a lower microchannel cooling assembly 266, at least one coil 268, a coil core 270, an upper microchannel cooling assembly 272 (see FIG. 8), and a top plate 274 (see FIG, 8). Note that the orientation of each cod unit 258 in each group is the same, and that the orientation changes (horizontal to vertical and vertical to horizontal) from one group to the next. In each coil unit 258, the coil may be split into two coil halves 268a, 268b, wherein the upper microchannel cooling assembly 272 thermally contacts the upper coil half 268a, and the lower microchannel cooling assembly 266 thermally contacts the lower coil half 268b. Each coil unit 258 is held together by respective bolts not shown) inserted into corresponding holes 276 in the plates 264, 274, in corresponding holes 278 in the upper cover plate 254, and in corresponding holes (not shown) in the lower cover plate. By tightening the bolts, the plates 264, 274 are urged together into intimate contact with the respective microchannel cooling assemblies 266, 272 of each coil unit 258 as the microchannel cooling assemblies 266, 272 are urged together into intimate contact with the respective coil(s) 268.

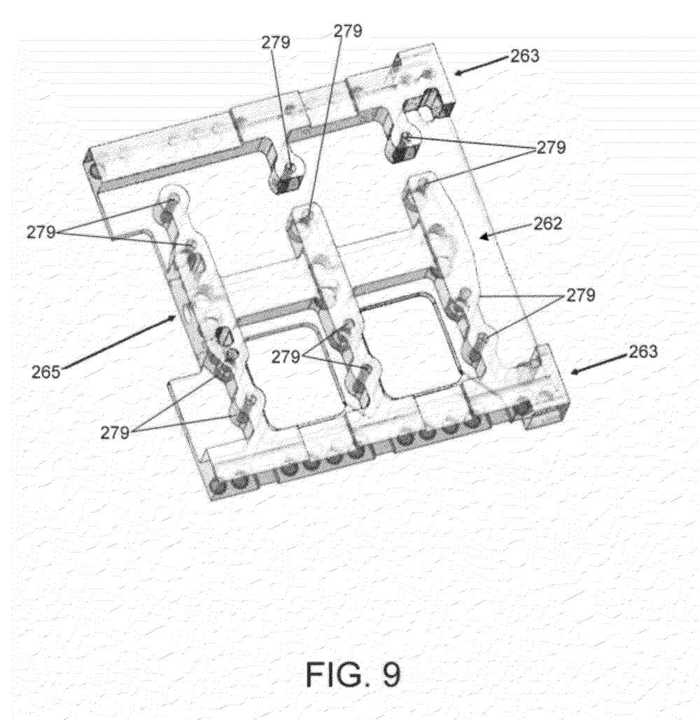

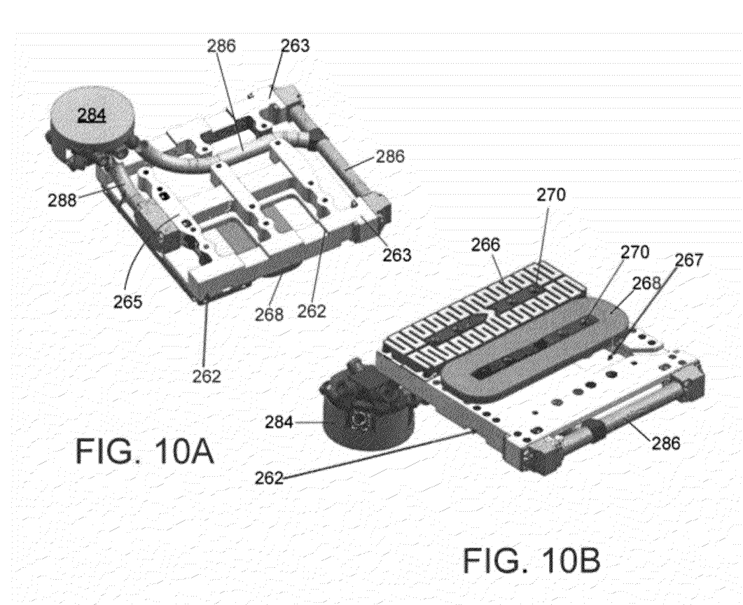

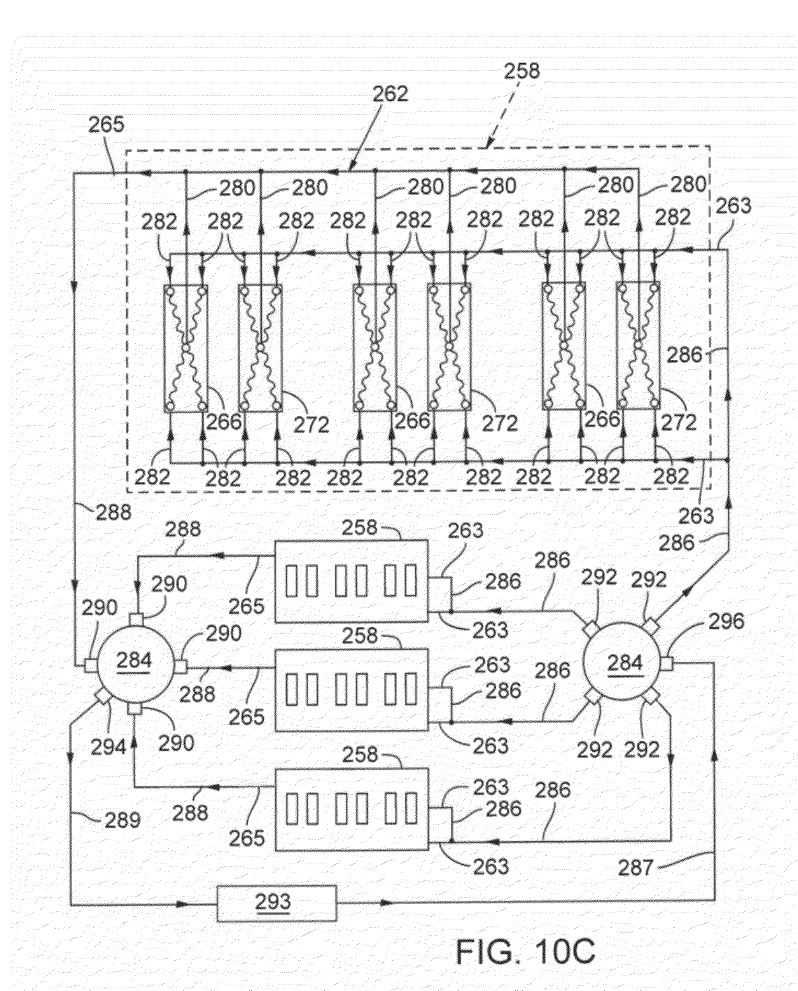

In FIG. 8 the microchannel cooling assemblies 266, 272 include respective fittings 280, 282 that connect to corresponding holes in the respective quarter-motor manifold plate 262 (FIG. 9); these connections are sealed by respective O-rings (not shown) or other suitable means. Each quarter-motor manifold plate 262 has at least one coolant inlet 265 and at least one coolant outlet 263. Thus, liquid coolant is supplied to and removed from each of the microchannel cooling assemblies 266, 272 by the quarter-motor manifold plate 262 (FIG. 9). The quarter-motor manifold plate 262 receives fresh coolant from and delivers spent coolant to a manifold block 284 (FIGS. 6, 10A, 10B).

In FIGS. 10A-10C, tubes 287, 289 extend from the manifold block 284 to deliver fresh coolant from a coolant supply 293 (heat exchanger) to the manifold block and route spent coolant from the manifold block 284 to the coolant supply 293. The tube 287 is connected to a general inlet 296 of the manifold block 284, and the tube 289 is connected to a general outlet 294 of the manifold block 284. In the manifold block 284, the general inlet 296 connects to four outlets 292, and the general outlet 294 connects to four inlets 290. Each outlet 292 is connected via a respective tube 286 to two respective inlets 263 on the quarter-motor manifold plate 262 of a respective coil unit 258. Each inlet 290 is connected via a respective tube 288 to a respective outlet 265 on the quarter-motor manifold plate 262. The quarter-motor manifold plate 262 then divides the inlet flow to the inlet fittings 282 of the microchannel cooling assemblies 266, 272 (a total of six in each coil unit 258). Coolant flow through the microchannel cooling assemblies 266, 272 is in an X-serpentine manner in which coolant enters each assembly at the termini of the arms of the “X” and exits each assembly at the center of the “X.” Thus, the coolant flows radially inward in a serpentine manner along each arm of the “X.” From the cooling assemblies 266, 272, spent coolant exits via outlet ports 280 to outlet conduits 265. The outlet conduits 265 are connected via a general outlet conduit 288 to a respective inlet port 290 of the manifold block 284. In the manifold block 284, the inlet ports 290 are connected to the general outlet 294, which is connected via a tube 289 to the coolant source 293, where the cycle repeats. Note that the entire flow of coolant is parallel to the coil units 258, through the coil units, and through the microchannel cooling assemblies 266, 272 of each coil unit 8 to cool all twelve coils 268 simultaneously.

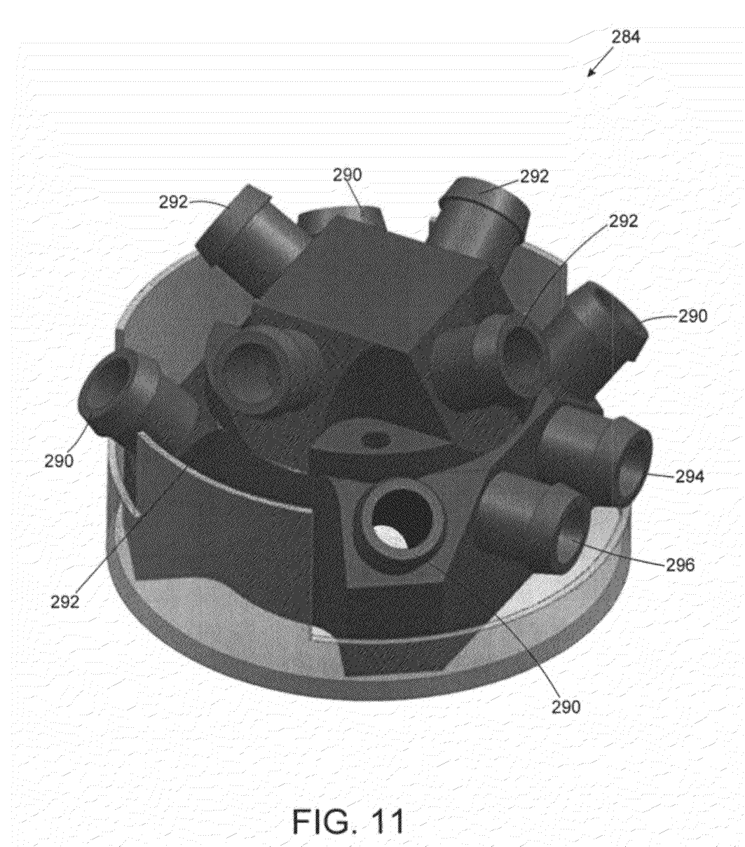

For connection to the four quarter-motor manifold plates 262, the manifold block 284 includes four outlet ports 292 (FIG. 11) that are connected to respective coolant inlets 263 of the four quarter-motor manifold plates 262. The four outlet ports 292 simultaneously receive fresh coolant entering the manifold block 284 via its general inlet port 296. The manifold block 284 also includes four inlet ports 290 that receive spent coolant from the four quarter-motor manifold plates 262 and deliver the spent coolant via the general outlet 294 to the coolant supply 293.

In FIG. 10C, the coolant source 293 can also supply coolant to other destinations, such as but not limited to the stage coupled to and movable by the subject planar motor.

This embodiment provides at least the following advantages:

(a) more compact arrangement of the system for cooling the motor coils in a planar motor;

(b) eliminates having to pot the coils;

(c) simplifies the coil assembly by making it modular, in which defective coils and other parts can he individually removed as needed instead of replacing the entire motor-coil assembly;

(d) provides better thermal performance than conventional cooling systems;

(e) eliminates the need for a large pressure vessel to contain coolant around the coils;

(f) by eliminating the pressure vessel, it eliminates the need for electrical pass-throughs through it;

(g) the modular construction of the coil assembly provides for easy maintenance as required; and

(h) since each coil is individually cooled using its own respective cooling plates having particular configurations, production of electrical eddy-current drag is substantially reduced.

Whereas this embodiment was described and shown in the context of a moving-coil commutator for use in a moving-coil planar motor, it will be understood that this embodiment can also be utilized in a moving-magnet type of planar motor. See the Fourth Representative Embodiment.

### Fourth Representative Embodiment

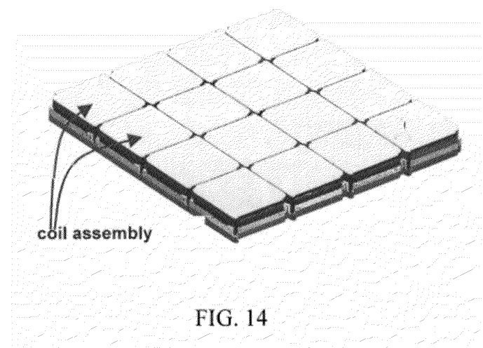

This embodiment is directed to an array of coil assemblies in which each coil assembly is configured substantially as disclosed in the Third Representative Embodiment. In FIG. 14, a 4×4 arrangement of 16 coil assemblies is shown. Referring to FIG. 7, it will be readily appreciated that the general alternating arrangement of four coil assemblies shown in that figure can be expanded ad infinitum in the same plane. Adding more coil assemblies can he employed, if needed or desired, in the commutator of a moving-coil planar motor. Multiple coil assemblies can also be utilized in a moving-magnet planar motor in which an alternating arrangement of coil assemblies serves as the stator, while the commutator is an array of permanent magnets.

Key advantages of this embodiment are similar to those of the Third Representative Embodiment, listed above. In a stationary array of coil assemblies in a moving-magnet planar motor, coil maintenance is an issue. This particular embodiment, in which each coil assembly has a modular construction, provides a substantial improvement in coil maintenance, compared to conventional planar motors.

### Fifth Representative Embodiment

In this embodiment, cooling plates are provided that can he placed in thermal contact with respective motor coils. For example, the cooling plate(s) can be placed adjacent to and coextensive with the motor coil. From a strictly thermal point of view, the cooling plates can be made of copper, aluminum, or other metal (e.g., brass or titanium alloy) having high thermal conductivity. These metals are also excellent electrical conductors, which poses a risk that electrical eddy-currents may form in them. Production of electrical eddy-currents in electrically conductive cooling plates can be substantially reduced by avoiding, for example, any large continuous areas in the cooling plates. One way in which to avoid large continuous areas is to make the cooling plate as thin as possible. Another way is to form the “plate” as a narrow, convoluted liquid conduit, such as a conduit bent into a fine, serpentine pattern. Such a pattern is readily made as a microchannel(s).

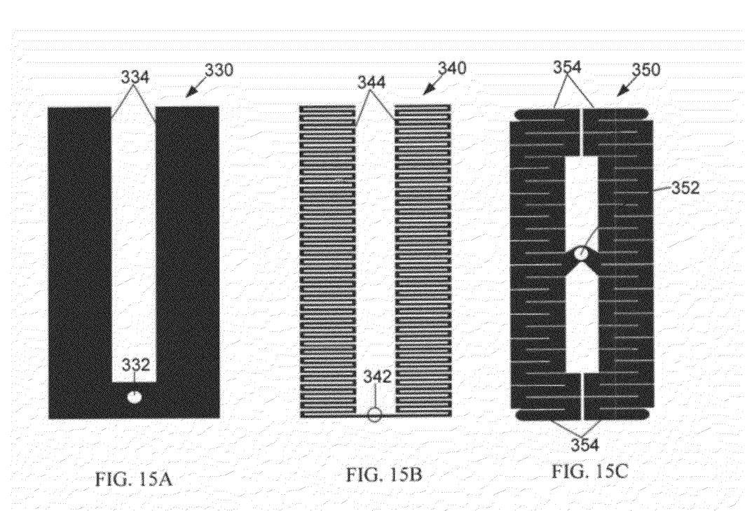

Example cooling plates collectively depicting this embodiment are shown in FIGS. 15A-15C. In the pattern 330 shown in FIG. 15A, the coolant channel has only a primary pattern in the general shape of a “U.” Coolant enters via an inlet port 332 at the bottom of the “U,” flows through the two arms 334 of the “U,” and exits at the top of the arms. Compared to cooling plates shaped like a solid rectangular sheet covering the entire coil (i.e., filling in the center area of the “U”), or a complete loop (i.e., connecting the top of the “U” arms to make an “O” shape), the pattern 330 reduces the amount of electrical eddy-current in the cooling plate. However, in certain applications, the eddy-current in the pattern 330 may still be unacceptably large because the arms 334 may be sufficiently wide to produce electrical eddy-currents. In FIG. 15B, the coolant channel 340 has a primary “U”-shape, but also includes a fine, serpentine secondary pattern within each arm of the “U.” As in FIG. 15A, in FIG. 15B the coolant is introduced via an inlet 342 at the bottom of the “U.” As the coolant flows through the arms 344 of the “U,” the coolant flows back and forth in the serpentine channel toward the top of each arm. The serpentine pattern breaks up the area of the cooling plate and thus eliminates a condition that otherwise would favor formation of electrical eddy-currents. Hence, the configuration of FIG, 15B tends to generate less eddy-current drag than the configuration of FIG. 15A. Applicants' tests have revealed that the electrical eddy-current produced by the cooling plate 340 shown in FIG, 15B is approximately 1000× less than produced by the plate 330 shown in FIG. 15A.

FIG. 15C is an example of a cooling plate in which the coolant channels are in an “X”-shaped primary pattern 350. Each arm of the X includes a serpentine secondary pattern. Coolant enters substantially in the center of the primary pattern (via inlet 352) and then flows in a serpentine manner to the end of the respective arm of the “U.” The pattern 350 in FIG. 15C has been seen to produce about 10x less electrical eddy-current than the pattern 330 shown in FIG. 15A. By providing more inhibition of electrical eddy-current formation, a pattern allows more freedom in choice of material of which the cooling plate may be made.

The microchannel primary and secondary patterns described herein, particularly the “X”-shaped primary patterns and finely serpentine secondary patterns, also minimize the number of static seals while still providing good flow of coolant and good heat-removal coverage of the coil surfaces.

### Sixth Representative Embodiment

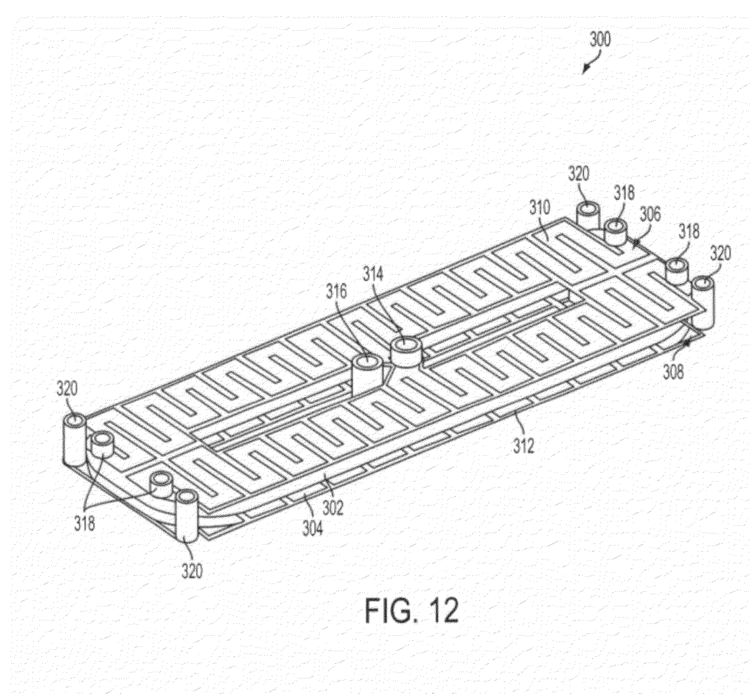

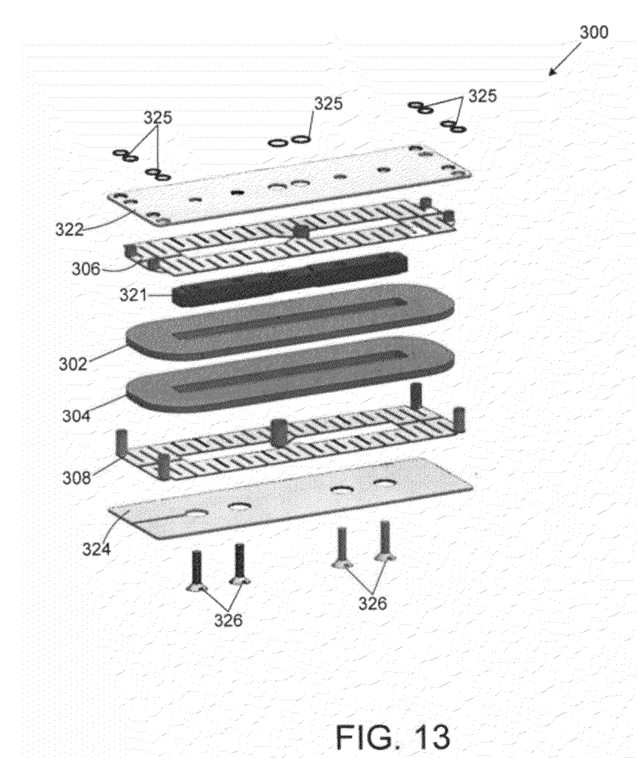

This embodiment is directed to coil units that include respective cooling plates configured as shown in FIG. 15C and discussed in the fifth representative embodiment. The cooling plates are shown in FIG. 12, which depicts an exemplary coil unit 300 usable with, for example, the third representative embodiment. In the figure, two coils 302, 304 are sandwiched between respective cooling plates 306, 308. Each cooling plate 306, 308 includes a respective X-shaped primary pattern with a serpentine microchannel secondary pattern 310, 312 configured to conduct flow of coolant through substantially the entire respective cooling plate. The serpentine microchannels 310, 312 obtain coolant from respective inlet fittings 314, 316 that are centrally located and connected to a source of coolant. The serpentine microchannels 310, 312 are also provided with respective coolant outlet fittings 318, 320 located at the ends of the legs of the “X” and connected to return the coolant to the source. Note that the inlet and outlet fittings all extend to the same height, which facilitates their connection to a manifold plate or the like, such as that described in the third representative embodiment. These connections are, in this embodiment, compression fittings utilizing respective O-rings 325 (FIG. 13).

An exploded view of a coil unit 300 is shown in FIG. 13, in which the two coil halves 302, 304 (with core 321), the upper cooling plate 306, and lower cooling plate 308 are shown. Also shown are an upper cover plate 322 and a lower cover plate 324. If the cover plates 322, 324 do not serve a cooling role, they can he made of any of a wide variety of electrically non-conductive and thermally low-conductive materials.

The cover plates 322, 324 can serve a role other than a cooling role. For example, the cover plates 322, 324 can serve a thermal isolation role. When used for thermal isolation, the cover plates 322, 324 contribute to controlling the temperature outside the coil unit 300. More specifically, the cover plates 322, 324 can be used to shield radiation of heat from one or more surfaces of the cooling plates 306, 308. For such a purpose, the cover plates 322, 324 can be made of or include CFRP for use as heat insulation serving to, inter alia, render uniform the temperature of the coil unit 300. Another material of which the cover plates 322, 324 can be made for purposes of heat insulation is any of various filter materials, used alone or in combination with other materials.

The cover plates 322, 324 can include liquid channels for flowing a fluid (e.g., gaseous such as air or a liquid coolant) for controlling and/or reducing heat as described above for the cooling plates. Liquid coolant can be supplied from the same coolant supply 293 via a manifold block (FIG. 10C) as used to supply coolant to the cooling plates. Thus, the temperature of the cover plates 322, 324 can be controlled as desired. In these configurations, the cover plates 322, 324 can be arranged such that respective areas outboard of the surfaces of the cover plates are shielded by said plates from the respective surfaces of the cooling plates 306, 308, and the magnet assembly of the motor is thermally shielded by the cover plates 322, 324 from the coil assemblies of the motor.

As described in the third representative embodiment, the coil halves 302, 304, core 321, and cooling plates 306, 308 are brought together into intimate thermal contact with each other and with the upper and lower cover plates 322, 324. Bolts 326 are used to hold the coil units in the motor structure.

The upper and lower cover plates 322, 324 are also used to protect the cooling plates 306, 308 from damage and to provide good mounting surfaces for the coil unit 300. The coil unit 300 can also include one or more thermocouples, thermistors or other temperature sensors (not shown), as needed or desired, to monitor coil temperature. Wires from the sensors can be threaded through, for example, slits defined in one or both cover plates 322, 324.

The depicted coil unit 300 is configured to be mounted in a receptacle (not shown, but see third representative embodiment) that provides coolant flow to the coil unit.

Important advantages and features of this embodiment include:

(1) The use of microchannels provides a compact and lightweight coil-cooling system that makes efficient use of the available coolant flow.

(2) The cooling plates 306, 308 desirably are made of a highly thermally conductive material. Since they are particularly configured to prevent formation of electrical eddy-currents, there is considerable flexibility in material selection for fabricating the plates. Copper is particularly advantageous because it is easy to manufacture and has high thermal conductivity. Alternatively to copper, another material having less electrical conductivity than copper (such as brass or titanium alloy) may be used to further reduce the production of (due to lower electrical conductivity) eddy-current drag while providing better corrosion resistance than can be realized using copper, for example.

### Seventh Representative Embodiment

Turbulent flow of coolant provides better heat transfer across a solid boundary to the liquid than laminar flow. However, typical constraints on size of the electromagnetic, actuators and coolant-flow velocities make it difficult to achieve and maintain a fully turbulent flow throughout the heat-transfer region. Also, the achievable Reynolds number is relatively low in many actuator-cooling applications, making it difficult to maintain a fully turbulent flow throughout the heat-transfer region. This results in thermal stratification in the flowing liquid, which reduces the heat-transfer rate.

This embodiment exploits the phenomenon of non-turbulent (viscous shear) mixing (also called “static mixing”) to increase the temperature gradient in the liquid near the solid-liquid boundary without having to rely on turbulent mixing. Increasing the temperature gradient increases the efficiency with which heat exchange can occur from the coil windings to the coolant, compared to laminar flow. Increasing the amount of static mixing achieves improved mixing of warmer liquid at the boundary with cooler liquid out in the flow. This can be achieved at very low Reynolds numbers, since it does not depend upon turbulence to improve mixing.

In this embodiment, static-mixing is established by placing a material in the flow that contorts the actual flow of coolant liquid past a surface from which heat is to be removed by the flowing coolant. For example, according to this embodiment, a unit of open-cell material is placed in the coolant flow path adjacent a coil such that liquid flow is urged through the open-cell material around the various structures and interstices of the open-cell foam material to improve the heat transfer across the solid-liquid boundary. A favorable rate of heat rejection into the coolant is achieved through the use of non-turbulent (“viscous shear”) mixing, also known as “static mixing,” using structures sometimes known as “static mixers,” Static mixing also increases the temperature gradient near the boundary by mixing the warm liquid very close to the boundary with cooler liquid from farther out in the flow. This can be achieved in laminar flows at extremely low Reynolds numbers, since the mechanism does not depend on turbulence to provide mixing.

An exemplary static mixer is open-cell “foam” (e.g., a metal foam or a polymer foam) placed in the coolant flowpath. The physical structure of the static mixer is not limited to foams. An alternative configuration is, for example, is a compressed matrix of fibers.

The available space in the coolant flowpath for placement of a unit of open-cell material may be very limited. A consideration of pressure drop across the unit desirably is also considered, which may dictate the sizes and distribution of pores and other factors. Suitable materials are not limited to the approximately 0.5-1.0 mm pore diameter in many polymeric open-cell foams. Desirably, the unit of open-cell material as placed at a situs in the coolant flowpath is slightly compressed to ensure liquid flow occurs through the open cells and not principally around the open-cell material.

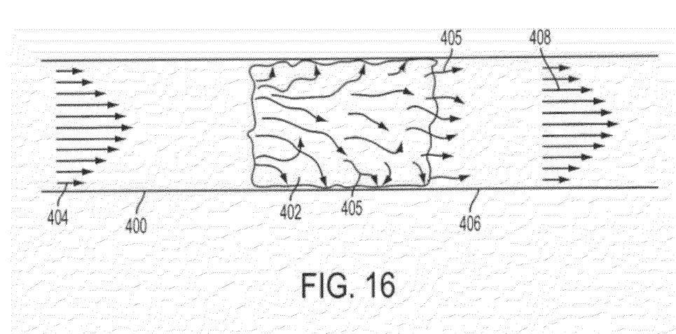

The static mixing phenomenon is depicted in FIG. 16, which depicts a flow conduit 400 in which a unit of open-cell material 402 has been placed. Coolant flows from left to right in the figure, and its flow vectors 404 indicate substantially laminar flow. Note that none of the flow vectors 404 is directed to the walls 406 of the conduit 400. As the flow enters and passes through the open-cell material 402, the flow vectors 405 become contorted, and some of them become directed toward the walls 406. This directing of flow vectors toward the wall 406 increases the efficiency with which heat is transferred from the wall to the liquid coolant. Downstream of the unit of open-cell material the flow of coolant typically becomes laminar again 408.

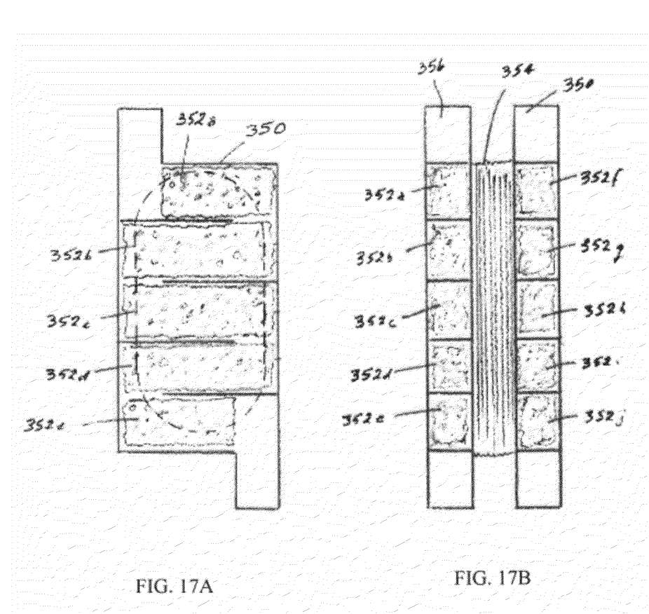

By way of example, respective units of open-cell material 352a-352e having sufficiently small pore size can be placed at selective locations in a microchanneled coolant flowpath 350, as shown in FIG. 17A. Such a flowpath 350 can be situated on one side of a coil 354, or on both sides as shown in FIG. 17B.

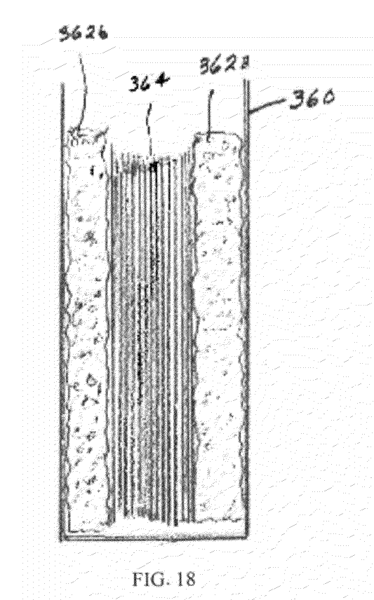

Alternatively, as shown in FIG. 18, respective units 362a, 362b of flow-mixing open-cell material are placed relative to a coil 364 in respective coolant passages located on each side of a coil in a conventional cooling jacket.

In our testing involving one specific planar motor, use of viscous-flow static mixers increased the heat-transfer rate at a given coolant flow rate by approximately 33%.

Notable features of this embodiment are:

(a) This mixing of viscous flow can be applied to many conventional schemes for cooling motor coils as well as to any of the specific embodiments disclosed herein.

(b) This embodiment is also applicable to many other electromagnetic actuators such as planar motors, VCM's (voice-coil motors) or E-core actuators. It has utility in most applications where the actuator size and the feasible range of flow rates result in Reynolds numbers that are too low to guarantee lay turbulent flow throughout the heat-transfer area.

(c) Heat rejection is significantly improved with the same or even with slightly lower coolant flow rates,

### Eighth Representative Embodiment

An example of a precision system with which electromagnetic actuators as described herein, particularly linear and/or planar motors, can he used is an immersion microlithography system.

Turning now to FIG, 19, certain features of an immersion lithography system are shown, namely, a light source 540, an illumination-optical system 542, a reticle stage 544, a projection-optical system 546, and a wafer (substrate) stage 548, all arranged along an optical axis A. The light source 540 is configured to produce a pulsed beam of illumination light, such as DUV light of 248 nm as produced by a KIT excimer laser, DUV light of 193 nm as produced by an ArF excimer laser, or DUV light of 157 nm as produced by an F₂ excimer laser. The illumination-optical system 542 includes an optical integrator and at least one lens that conditions and shapes the illumination beam for illumination of a specified region on a patterned reticle 550 mounted to the reticle stage 544. The pattern as defined on the reticle 550 corresponds to the pattern to be transferred lithographically to a wafer 552 that is held on the wafer stage 548. Lithographic transfer in this system is by projection of an aerial image of the pattern from the reticle 550 to the wafer 552 using the projection-optical system 546. The projection-optical system 545 typically comprises many individual optical elements (not detailed) that project the image at a specified demagnification ratio (e.g., 1/4 or 1/5) on the wafer 552. So as to be imprintable, the wafer surface is coated with a layer of a suitable exposure-sensitive material termed a “resist.”

The reticle stan 544 is configured to move the reticle 550 in the X-direction, Y-direction, and rotationally about the Z-axis. To such end, the reticle stage is equipped with one or more linear motors having cooled coils as described herein. The two-dimensional position and orientation of the reticle 550 on the reticle stage 544 are detected by a laser interferometer (not shown) in real time, and positioning of the reticle 550 is effected by a main control unit on the basis of the detection thus made.

The wafer 552 is held by a wafer holder (“chuck,” not shown) on the wafer stage 548. The wafer stage 548 includes a mechanism (not shown) for controlling and adjusting, as required, the focusing position (along the Z-axis) and the tilting angle of the wafer 552. The wafer stage 548 also includes electromagnetic actuators (e.g., linear motors or a planar motor, or both) for moving the wafer in the X-Y plane substantially parallel to the image-formation surface of the projection-optical system 546. These actuators desirably comprise linear motors, one more planar motors, or both. Desirably, these actuators have cooled coils as described herein.

The wafer stage 548 also includes mechanisms for adjusting the tilting angle of the wafer 552 by an auto-focusing and auto-leveling method. Thus, the wafer stage serves to align the wafer surface with the image surface of the projection-optical system. The two-dimensional position and orientation of the wafer are monitored in real time by another laser interferometer (not shown). Control data based on the results of this monitoring are transmitted from the main control unit to a drive circuits for driving the wafer stage. During exposure, the light passing through the projection-optical system is made to move in a sequential manner from one location to another on the wafer, according to the pattern on the reticle in a step-and-repeat or step-and-scan manner.

The projection-optical system 546 normally comprises many lens elements that work cooperatively to firm the exposure image on the resist-coated surface of the wafer 552. For convenience, the most distal optical element (i.e., closest to the wafer surface) is an objective lens 553. Since the depicted system is an immersion lithography system, it includes an immersion liquid 554 situated between the objective lens 553 and the surface of the wafer 552. As discussed above, the immersion liquid 554 is of a specified type. The immersion liquid is present at least while the pattern image of the reticle is being exposed onto the wafer.

The immersion liquid 554 is provided from a liquid-supply unit 556 that may comprise a tank, a pump, and a temperature regulator (not individually shown). The liquid 554 is gently discharged by a nozzle mechanism 555 into the gap between the objective lens 553 and the wafer surface. A liquid-recovery system 558 includes a recovery nozzle 57 that removes liquid from the gap as the supply 56 provides fresh liquid 554. As a result, a substantially constant volume of continuously replaced immersion liquid 554 is provided between the objective lens 553 and the wafer surface. The temperature of the liquid is regulated to be approximately the same as the temperature inside the chamber in which the lithography system itself is disposed.

Also shown is a sensor window 560 extending across a recess 562, defined in the wafer stage 548, in which a sensor 564 is located. Thus, the window 560 sequesters the sensor 564 in the recess 562. Movement of the wafer stage 548 so as to place the window 560 beneath the objective lens 553, with continuous replacement of the immersion fluid 554, allows a beam passing through the projection-optical system 546 to transmit through the immersion fluid and the window 560 to the sensor 564.

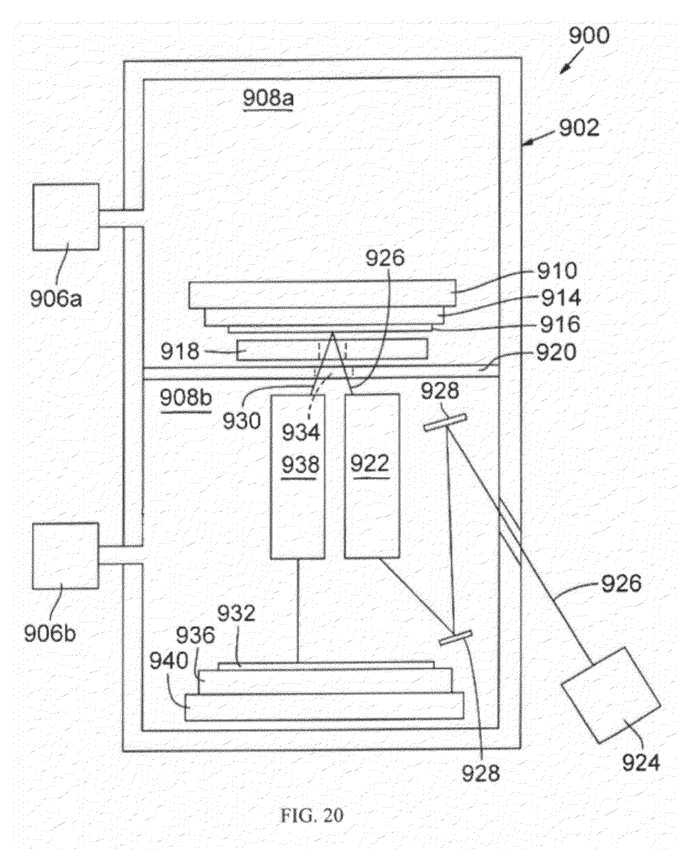

Referring now to FIG. 20, an alternative embodiment of a precision system that can include one or more electromagnetic actuators having actively cooled coils as described herein is an EUVL system 900, as a representative precision system incorporating an electromagnetic actuator as described herein, is shown. The depicted system 900 comprises a vacuum chamber 902 including vacuum pumps 906a, 906b that are arranged to enable desired vacuum levels to be established and maintained within respective chambers 908a, 908b of the vacuum chamber 902. For example, the vacuum pump 906a maintains a vacuum level of approximately 50 mTorr in the upper chamber (reticle chamber) 908a, and the vacuum pump 906b maintains a vacuum level of less than approximately 1 mTorr in the lower chamber (optical chamber) 908b. The two chambers 908a, 908b are separated from each other by a barrier wall 920. Various components of the EUVL system 900 are not shown, for ease of discussion, although it will be appreciated that the EUVL system 900 can include components such as a reaction frame, a vibration-isolation mechanism, various actuators, and various controllers.

An EUV reticle 916 is held by a reticle chuck 914 coupled to a reticle stage 910. The reticle stage 910 holds the reticle 916 and allows the reticle to be moved laterally in a scanning manner, for example, during use of the reticle for making lithographic exposures. Between the reticle 916 and the barrier wall 920 is a blind apparatus. An illumination source 924 produces an EUV illumination beam 926 that enters the optical chamber 906b and reflects from one or more mirrors 928 and through an illumination-optical system 922 to illuminate a desired location on the reticle 916. As the illumination beam 926 reflects from the reticle 916, the beam is “patterned” by the pattern portion actually being illuminated on the reticle. The barrier wall 920 serves as a differential-pressure barrier and can serve as a reticle shield that protects the reticle 916 from particulate contamination during use. The barrier wall 920 defines an aperture 934 through which the illumination beam 926 may illuminate the desired region of the reticle 916. The incident illumination beam 926 on the reticle 916 becomes patterned by interaction with pattern-defining elements on the reticle, and the resulting patterned beam 930 propagates generally downward through a projection-optical system 938 onto the surface of a wafer 932 held by a wafer chuck 936 on a wafer stage 940 that performs scanning motions of the wafer during exposure. Hence, images of the reticle pattern are projected onto the wafer 932.

The wafer stage 940 can include (not detailed) a positioning stage that may be driven by a planar motor or one or more linear motors, for example, and a wafer table that is magnetically coupled to the positioning stage using an EI-core actuator, for example. The wafer chuck 936 is coupled to the wafer table, and may be levitated relative to the wafer table by one or more voice-coil motors, for example. If the positioning stage is driven by a planar motor, the planar motor typically utilizes respective electromagnetic forces generated by magnets and corresponding armature coils arranged in two dimensions. The positioning stage is configured to move in multiple degrees of freedom of motion, e.g., three to six degrees of freedom, to allow the wafer 932 to be positioned at a desired position and orientation relative to the projection-optical system 938 and the reticle 916.

An EUVL system including the above-described EUV-source and illumination-optical system can be constructed by assembling various assemblies and subsystems in a manner ensuring that prescribed standards of mechanical accuracy, electrical accuracy, and optical accuracy are met and maintained. To establish these standards before, during, and after assembly, various subsystems (especially the illumination-optical system 922 and projection-optical system 938) are assessed and adjusted as required to achieve the specified accuracy standards. Similar assessments and adjustments are performed as required of the mechanical and electrical subsystems and assemblies. Assembly of the various subsystems and assemblies includes the creation of optical and mechanical interfaces, electrical interconnections, and plumbing interconnections as required between assemblies and subsystems. After assembling the EUVL system, further assessments, calibrations, and adjustments are made as required to ensure attainment of specified system accuracy and precision of operation. To maintain certain standards of cleanliness and avoidance of contamination, the EUVL system (as well as certain subsystems and assemblies of the system) are assembled in a clean room or the like in which particulate contamination, temperature, and humidity are controlled.

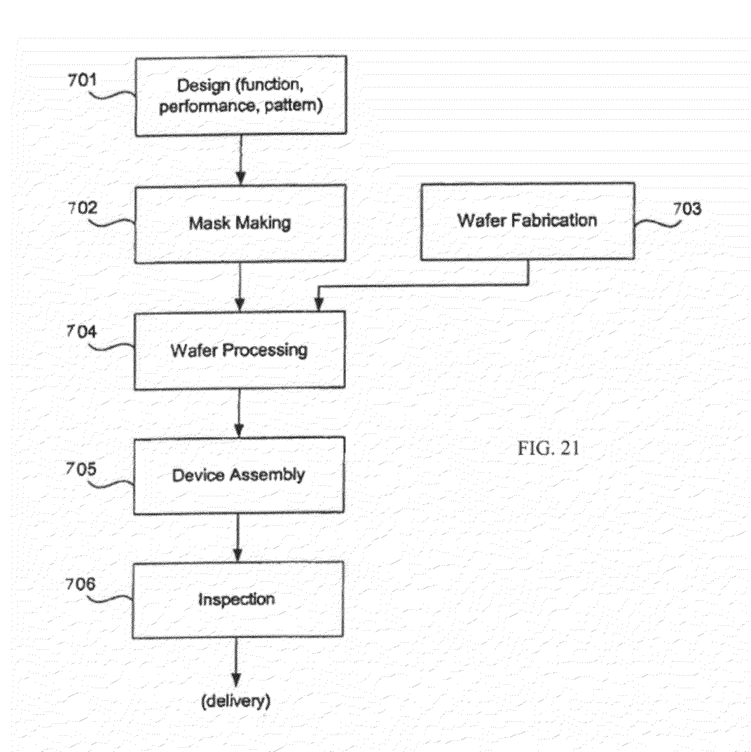

Semiconductor devices can be fabricated by processes including microlithography steps performed using a microlithography system as described above. Referring to FIG. 21, in step 701 the function and performance characteristics of the semiconductor device are designed. In step 702 a reticle (“mask”) defining the desired pattern is designed and fabricated according to the previous design step. Meanwhile, in step 703, a substrate (wafer) is fabricated and coated with a suitable resist. In step 704 (“wafer processing”) the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to particular locations on the chips, and “packaging” by which the devices are enclosed in appropriate packages for use). In step 706 the assembled devices are tested and inspected.

Representative details of a wafer-processing process including a microlithography step are shown in FIG, 22. In step 711 (“oxidation”) the wafer surface is oxidized. In step 712 (“CVD”) an insulative layer is formed on the wafer surface by chemical-vapor deposition. In step 713 (electrode formation) electrodes are formed on the wafer surface by vapor deposition, for example. In step 714 (“ion implantation”) ions are implanted in the wafer surface. These steps 711-714 constitute representative “pre-processing” steps for wafers, and selections are made at each step according to processing requirements.

At each stage of wafer processing, when the preprocessing steps have been completed, the following “post-processing” steps are implemented. A first post-process step is step 715 (“photoresist formation”) in which a suitable resist is applied to the surface of the wafer. Next, in step 716 (“exposure”), the microlithography system described above is used for lithographically transferring a pattern from the reticle to the resist layer on the wafer. In step 717 (“developing”) the exposed resist on the wafer is developed to form a usable mask pattern, corresponding to the resist pattern, in the resist on the wafer. In step 718 (“etching”), regions not covered by developed resist (i.e., exposed material surfaces) are etched away to a controlled depth. In step 719 (“photoresist removal”), residual developed resist is removed (“stripped”) from the wafer.

Formation of multiple interconnected layers of circuit patterns on the wafer is achieved by repeating the pre-processing and post-processing steps as required. Generally, a set of preprocessing and post-processing steps are conducted to form each layer.

It has not escaped our notice that the various embodiments are not limited to performing cooling. Rather, they can be used to change and regulate the temperature of the coils, and this may require increasing the temperature of the coils.

Whereas the invention has been described in connection with representative embodiments, it will be understood that it is not limited to those embodiments. On the contrary, it is intended to encompass all alternatives, modifications, and equivalents as may he included within the spirit and scope of the invention as defined by the appended claims.

What is claimed is:

1. In a linear or planar motor, an actively cooled coil assembly, comprising:
a coil having first and second main surfaces;
a respective thermally conductive cooling plate in thermal contact with at least one main surface of the coil;
a coolant passageway defined in or on the cooling plate; and
a liquid coolant passing through the coolant passageway;
wherein the coolant passageway has a primary pattern that is coextensive with at least part of the main surface of the coil.

2. The assembly of claim 1, wherein the primary pattern is a shape lacking large continuous areas to reduce eddy-current losses in the cooling plate.

3. The assembly of claim 2, wherein the primary pattern is an X-shaped pattern including arms having respective termini.

4. The assembly of claim 2, wherein the primary pattern is serpentine.

5. The assembly of claim 2, wherein the primary pattern is a U-shaped pattern including arms having respective termini.

6. The assembly of claim 1, wherein the primary pattern is serpentine.

7. The assembly of claim 1, wherein the primary pattern is U-shaped.

8. The assembly of claim 1, wherein the primary pattern includes a secondary pattern.

9. The assembly of claim 8, wherein the secondary pattern is a shape lacking large continuous areas to reduce eddy-current losses in the cooling plate.

10. The assembly of claim 10, wherein the secondary pattern is serpentine.

11. The assembly of claim 1, wherein the primary pattern is X-shaped including arms having respective termini.

12. The assembly of claim 11, further comprising either a coolant inlet or a coolant outlet situated substantially in a middle of the X-shaped primary pattern and respective coolant outlets or inlets, respectively, situated substantially at the termini of the arms, wherein:
coolant flow enters the coolant passageway through the inlet, flows through the arms, and exits the coolant passageway through the outlets; and
the secondary pattern extends along each arm to impose a non-cyclic flow of coolant as the coolant flows through the arms.

13. The assembly of claim 11, further comprising respective coolant inlets located at the termini of the arms and at least one coolant outlet situated substantially in a middle of the X-shaped primary pattern, wherein:
coolant flow enters the coolant passageway through the inlets, flows through the anus, and exits the coolant passageway through the at least one outlet; and
the secondary pattern extends along each arm to impose a non-cyclic flow of coolant as the coolant flows through the arms.

14. The assembly of claim 11, further comprising at least one coolant inlet situated substantially at least one of the termini, and at least one coolant outlet situated substantially at the remaining termini.

15. The assembly of claim 1, wherein:
the primary pattern is a radial pattern having a center and multiple arms radiating from the center;
at least one arm has a distal terminus including a coolant outlet or inlet; and
at least one arm includes a secondary pattern of microchannels.

16. The assembly of claim 15, wherein:
the center includes a coolant inlet or outlet; and
at least one arm has a distal terminus including a coolant outlet or inlet, respectively.

17. The assembly of claim 1, wherein:
the coil includes first and second planar main surfaces;
at least one main surface includes a respective cooling plate in thermal contact therewith;
at least one cooling plate includes a respective coolant passageway defined in or on the cooling plate; and
at least one cooling plate includes a liquid coolant passing through the coolant passageway.

18. The assembly of claim 17, wherein:
at least one each coolant passageway has a primary pattern that is coextensive with the respective main surface of the flat coil, and
the primary pattern is configured to reduce the extent of continuous area, and thereby reduces eddy-current losses in the cooling plate.

19. The assembly of claim 18, wherein the primary pattern includes a respective secondary pattern that further reduces the extent of continuous area and thereby further reduces eddy-current losses in the cooling plate.

20. The assembly of claim 1, further comprising a plate situated such that the cooling plate is sandwiched between the plate and the coil, the plate being configured to be compressed toward the coil to improve thermal contact of the cooling plate with the respective main surface of the coil.

21. The assembly of claim 1, further comprising a static mixer located in at least a portion of the coolant passageway.

22. The assembly of claim 1, further comprising a thermally conductive substance between the cooling plate and the respective main surface of the coil.

23. An electromagnetic motor, comprising:
a coil array comprising at least one electrically energizable coil; and
at least one respective unit of thermally conductive material in thermal contact with the at least one coil so as to conduct heat from the respective coil, the at least one unit of thermally conductive material defining a respective coolant passageway and
a thermally conductive liquid coolant in the coolant passageway;
wherein the coolant flowing in the coolant passageway is in thermal contact with the respective unit of thermally conductive material to remove heat from the respective unit of thermally conductive material and thus from the respective coil.

24. The motor of claim 23, wherein:
the coolant passageway has a primary pattern coextensive with at least a portion of the at least one coil; and
the primary pattern is configured to reduce the extent of continuous area, and thereby reduce eddy-current losses in the thermally conductive material.

25. The motor of claim 24, wherein the primary pattern includes a respective secondary pattern that further reduces the extent of continuous area and thereby further reduces eddy-current losses in the cooling plate.

26. The motor of claim 23, wherein the motor is either a linear motor or a planar motor.

27. The motor of claim 23, wherein;
the motor is a linear or planar motor including multiple coils;
at least one coil is a relatively flat coil having at least one respective substantially planar main surface;
at least one main surface includes a respective unit of the thermally conductive material in thermal contact therewith, the unit of thermally conductive material being configured as a coolant plate;
at least one coolant plate has a substantially planar surface in thermal contact with the respective main surface of the respective coil in the respective coil unit; and
at least one coolant plate defines a coolant passageway.

28. The motor of claim 27, wherein at least one coil is incorporated into a respective coil unit.

29. The motor of claim 27, wherein:
at least one coolant plate defines a coolant passageway;
the coolant passageway has a primary pattern coextensive with at least a portion of the respective coil; and
the primary pattern is configured to reduce the extent of continuous area, and thereby reduce eddy-current losses in the thermally conducive material.

30. The motor of claim 29, wherein the primary pattern includes a respective secondary pattern that further reduces the extent of continuous area and thereby further reduces eddy-current losses in the cooling plate.

31. The motor of claim 29, wherein the primary pattern is a radial pattern including a center and multiple arms radiating therefrom.

32. The motor of claim 30, wherein the secondary pattern is serpentine.

33. The motor of claim 32, wherein;
a planar surface of at least one coolant plate further comprises either a coolant inlet or a coolant outlet situated substantially in a middle of the radial primary pattern, and further comprises respective coolant outlets or inlets, respectively, situated substantially at the termini of the arms:
coolant flow enters the coolant passageway through the inlet, flows through the serpentine secondary pattern through the arms, and exits the coolant passageway through the outlets; and
the serpentine secondary pattern extends along each arm to impose a non-cyclic flow as the coolant flows through the arms.

34. The motor of claim 32, wherein:
the primary pattern is an X-pattern having a center and respective termini at ends of the arms;
the center includes either a coolant inlet or a coolant outlet;
respective coolant outlets or inlets, respectively, are situated substantially at the termini;
coolant flow enters the coolant passageway through at least one coolant inlet, flows through the arms, and exits the coolant passageway through at least one coolant outlet; and
the secondary pattern extends along a respective arm to impose a non-cyclic flow of coolant as the coolant flows through the arms.

35. The motor of claim 27, wherein:
at least one coil unit includes respective outer plates situated such that the respective cooling plates are sandwiched between the respective outer plates and at least one coil; and
at least one outer plate is configured to be urged toward the at least one coil to establish and maintain thermal contact of the respective cooling plate with the respective main surface of the respective coil.

36. The motor of claim 23, wherein at least one coolant passageway includes a respective static mixer located in the respective coolant passageway.

37. The motor of claim 23, wherein:
the motor is a planar motor in which a coil array comprises multiple coil units;
at least one coil unit comprises multiple coils;
at least one coil is a relatively flat coil having at least one respective substantially planar main surface;
in at least one coil unit, a main surface of a respective coil includes a respective unit of the thermally conductive material, the unit of thermally conductive material being configured as a coolant plate; and
at least one coolant plate defines a coolant passageway including the primary and secondary patterns.

38. The motor of claim 37, wherein:
the primary pattern is coextensive with at least a portion of the respective coil; and
the primary pattern is configured to reduce the extent of continuous area and thereby is configured to reduce eddy current loses in the coolant plate.

39. The motor of claim 38, wherein at least one primary pattern includes a respective secondary pattern that further reduces the extent of continuous area and thereby further reduces eddy-current losses in the coolant plate.

40. The motor of claim 36, further comprising a manifold connected to a supply of coolant and to at least one coolant plate so as to deliver coolant to said coolant plate simultaneously with removing spent coolant from the coolant plate.

41. A cooling device for an electrically actuated coil, comprising:
an actively cooled member in thermal contact with a coil, the cooled member having at least one liquid inlet and at least one liquid outlet so as to conduct cooling liquid through a liquid passageway in or on the member; and
a static-mixing structure situated in the liquid passageway and configured to induce mixing of the liquid as the liquid flows through the passageway.

42. The device of claim 41, wherein the static-mixing structure is an open-cell foam.

43. A linear motor comprising an actively cooled coil assembly as recited in claim 1.

44. A linear motor comprising an actively cooled coil assembly as recited in claim 41.

45. A planar motor comprising an actively cooled coil assembly as recited in claim 1.

46. A planar motor comprising an actively cooled coil assembly as recited in claim 41.

47. A precision system, comprising a movable body coupled to a linear motor as recited in claim 43.

48. A precision system, comprising a movable body coupled to a linear motor as recited in claim 44.

49. A precision system, comprising a movable body coupled to a planar motor as recited in claim 45.

50. A precision system, comprising a movable body coupled to a planar motor as recited in claim 46.

51. The precision system of claim 47 configured as a microlithography system.

52. The precision system of claim 48 configured as a microlithography system.

53. The precision system of claim 49 configured as a microlithography system.

54. The precision system of claim 50 configured as a microlithography system.

55. A stage, comprising at least one motor as recited in claim 23.

56. A precision system, comprising a stage as recited in claim 55.

57. The precision system of claim 56, configured as a microlithography system.

58. In a micro-device manufacturing method, a microlithography step performed using a microlithography system as recited in claim 51.

59. In a micro-device manufacturing method, a microlithography step performed using a microlithography system as recited in claim 52.

60. In a micro-device manufacturing method, a microlithography step performed using a microlithography system as recited in claim 53.

61. In a micro-device manufacturing method, a microlithography step performed using a microlithography system as recited in claim 54.

62. In a micro-device manufacturing method, a microlithography step performed using a microlithography system as recited in claim 57.

63. A semiconductor wafer manufactured by the micro-device manufacturing method recited in claim 58.

64. A semiconductor wafer manufactured by the micro-device manufacturing method recited in claim 59.

65. A semiconductor wafer manufactured by the micro-device manufacturing method recited in claim 60.

66. A semiconductor wafer manufactured by the micro-device manufacturing method recited in claim 61.

67. A semiconductor wafer manufactured by the micro-device manufacturing method recited in claim 62.

68. A hydraulic cooling circuit, comprising:
a source of coolant liquid;
a pump hydraulically connected to the source; and
an actively cooled coil assembly as recited in claim 1 hydraulically coupled to the source and the pump.

69. A motor device including a coil assembly and a magnet assembly that cooperates with the coil assembly for generating a force, the device comprising:
a coil having a coil surface;
a first member having a first surface and a second surface, the second surface being in thermal contact with the coil surface, and the first member having a shape that reduces eddy-current drag on the force;
a first passageway defined in or on the first member; and
a shielding member that thermally shields the first surface of the first member.

70. The motor device of claim 69, wherein the first member is shaped to reduce any-current losses.

71. The motor device of claim 69, wherein the shielding member at least partly contacts the first surface of the first member.

72. The motor device of claim 69, further comprising a second passageway defined in or on the shielding member.

73. The motor device of claim 72, further comprising a shield-temperature controller that controls a temperature of the shielding member to a desired temperature.
